(19) United States
(12) Patent Application Publication
(10) Pub. No.: US 2026/0254711 A1
(43) Pub. Date: Aug. 27, 2026

(54) ARTIFICIAL INTELLIGENCE-DRIVEN COLLABORATIVE NETWORK EVENT MANAGEMENT

(71) Applicant: Cisco Technology, Inc., San Jose, CA (US)

(72) Inventors: Randy Zhang, Herndon, VA (US); Shamin Aggarwal, Iselin, NJ (US)

(21) Appl. No.: 19/063,139

(22) Filed: Feb. 25, 2025

(51) Int. Cl. H04L 41/0659; H04L 41/22

(52) U.S. Cl. CPC H04L 41/0661; H04L 41/22

(57) ABSTRACT

Systems and methods for Artificial Intelligence (AI)-driven Collaborative Network Event Management (CNEM) are provided. An AI-driven CNEM system includes multiple AI agents operating in a collaborative cycle. The AI-driven CNEM system receives event information associated with a network environment. Using the AI agents, the AI-driven CNEM system receives and evaluates at least one event based on the event information, determines a network management operation based on the evaluation, and triggers at least one action, for example, a recommendation or an execution, associated with the network management operation. The AI agents have designated roles in the collaborative cycle and execute at least one machine learning model for the evaluation of the event(s). The AI-driven CNEM system implements continuous self-learning through previous actions and feedback. The AI-driven CNEM system operates based on an autonomous and collaborative event arbitration cycle that is grounded by local context and domain knowledge.

The present disclosure relates to network management. More particularly, the present disclosure relates to artificial intelligence-driven collaborative network event management.

### BACKGROUND

With the exponential growth of digital technologies and increasing dependence on interconnected networks, there is a growing need for robust network management. As network environments increase in size and complexity, network providers may face large volumes of network events, for example, device events, data traffic, network incidents, security events, messages, alerts, or the like each day. The sheer volume of the network events can be overwhelming, making it difficult for network managers to analyze and identify meaningful or critical network events. Moreover, processing and analyzing the large volumes of network events in real time or near-real time may substantially strain network infrastructure and security tools, thereby leading to slowdowns, for example, in event logging, processing, or alerting, resulting in potential delays in detecting issues.

Further, network environments are constantly evolving, with systems, applications, and network configurations changing frequently, thereby creating new vulnerabilities, bottlenecks, or performance issues that may need early detection and immediate attention. Some event management systems may utilize conventional machine learning techniques and predictive analytics for handing the large volumes of network events and frequent changes in the network environments. However, it may still be increasingly difficult to properly classify and prioritize the network events, and trigger timely actions. Further, network managers may face a new level of network events that may have been created or orchestrated by generative artificial intelligence models, which may not be identified and managed by conventional event management systems. As networks become more intricate and dynamic, conventional methods of manual or siloed automation may not be sufficient as they cannot keep up with the growing challenges and demands of expanding network environments.

### SUMMARY OF THE DISCLOSURE

Systems and methods for Artificial Intelligence (AI)-driven collaborative network event management in accordance with embodiments of the disclosure are described herein. In many embodiments, a system comprises a processor, a memory communicatively coupled to the processor, and a network event management logic. The memory comprises a plurality of AI agents configured to operate in a collaborative cycle. The network event management logic is configured to receive event information associated with a network environment, and using the plurality of AI agents: receive at least one event; evaluate the received at least one event based on the received event information, determine a network management operation based on the evaluation, and trigger at least one action associated with the determined network management operation.

In a number of embodiments, the event information is received from a local knowledge base configured to provide contextual information associated with the network environment.

In a variety of embodiments, the local knowledge base is configured as an embedding vector database.

In various embodiments, the network event management logic is further configured to receive feedback associated with the at least one action via a user interface, and update the local knowledge base based on the received feedback.

In more embodiments, the event information is received from a domain knowledge base configured to provide knowledge about a domain associated with the network environment.

In additional embodiments, the event information comprises one or more requirements associated with at least one policy corresponding to the network environment.

In further embodiments, the event information comprises at least one event category indicating a known event type and a meaning of the known event type.

In still more embodiments, the event information comprises at least one event action log associated with the network environment.

In still further embodiments, the network event management logic is further configured to update the at least one event action log based on the triggered at least one action.

In still additional embodiments, an AI agent of the plurality of AI agents is configured to execute at least one machine learning model for the evaluation of the received at least one event.

In some more embodiments, the evaluation of the received at least one event comprises: performing at least one classification of the received at least one event; evaluating the at least one classification; generating a relationship graph based on the evaluation; identifying one or more correlations between the received at least one event and another event associated with the network environment based on the generated relationship graph; and assigning a priority to each of the received at least one event and the another event based on the identified one or more correlations.

In yet various embodiments, the at least one action corresponds to one of a recommendation or an execution.

In yet more embodiments, an AI agent of the plurality of AI agents has a designated role in the collaborative cycle.

In still yet more embodiments, the network event management logic is further configured to render a user interface that facilitates one or more interactions between a user and the plurality of AI agents.

In many further embodiments, the triggering of the at least one action is based on the one or more interactions.

In many additional embodiments, the plurality of AI agents corresponds to generative AI agents.

In still yet further embodiments, the at least one action is revertible requesting a confirmation of the at least one action from at least one AI agent of the plurality of AI agents within a configurable expiration period.

In still yet additional embodiments, the collaborative cycle comprises autonomous arbitration corresponding to at least one of the received at least one event or the determined network management operation, by the plurality of AI agents.

In several embodiments, a system comprises a processor and a memory communicatively coupled to the processor and comprising a network event management logic. The network event management logic is configured to collect event information associated with a network environment, receive at least one event, execute an event arbitration cycle on the received at least one event using a plurality of AI agents based on the collected event information, and trigger at least one action based on the event arbitration cycle.

In several more embodiments, the event information is collected from at least one of: a local knowledge base configured to provide contextual information associated with the network environment; or a domain knowledge base configured to provide knowledge about a domain associated with the network environment.

In numerous embodiments, a method comprises: receiving event information associated with a network environment; deploying a plurality of AI agents; and executing, using the plurality of AI agents, a collaborative event arbitration cycle comprising: receiving at least one event; evaluating the received at least one event based on the received event information; determining a network management operation based on the evaluation; and triggering at least one action associated with the determined network management operation.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently disclosed embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments in which a network event management logic may operate on a plurality of network devices in accordance with various embodiments of the disclosure;

FIG. 2 is a schematic diagram illustrating various subsets of artificial intelligence in accordance with various embodiments of the disclosure;

FIG. 3 is a block diagram illustrating different methods of machine-based learning in accordance with various embodiments of the disclosure;

FIG. 4 is a block diagram illustrating a machine learning lifecycle in accordance with various embodiments of the disclosure;

FIG. 5 is a schematic diagram illustrating an example neural network in accordance with various embodiments of the disclosure;

FIG. 6 is a block diagram illustrating an Artificial Intelligence (AI)-driven collaborative network event management system in accordance with various embodiments of the disclosure;

FIG. 7 is a block diagram illustrating the AI-driven collaborative network event management system executing an event arbitration cycle in accordance with various embodiments of the disclosure;

FIG. 8 is a flowchart depicting a process for collaboratively managing events associated with a network environment in accordance with various embodiments of the disclosure;

FIG. 9 is a flowchart depicting a process for managing actions based on an event arbitration cycle in accordance with various embodiments of the disclosure;

FIG. 10 is a flowchart depicting a process for managing revertive actions based on an event arbitration cycle in accordance with various embodiments of the disclosure;

FIG. 11 is a flowchart depicting a process for collaborative role-based management of events associated with a network environment in accordance with various embodiments of the disclosure; and

FIG. 12 is a conceptual block diagram of a device suitable for configuration with the network event management logic for implementing the functionality and various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the issues described above, systems and methods are discussed herein for Artificial Intelligence (AI)-driven Collaborative Network Event Management (CNEM). The systems and methods discussed herein may provide an AI-driven CNEM system configured, for example, as an intelligent collaborative network event operator. The AI-driven CNEM system may include a plurality of AI agents configured to evaluate events associated with a network environment, determine network management operations, and trigger associated actions, based on an autonomous and collaborative cycle that is grounded by local context and knowledge. An AI agent may refer to an entity including any combination of hardware and software configured to perform one or more tasks autonomously based on an intended result, which may be derived from any other module, circuit, or AI agent within the AI-driven CNEM system, and to perform dynamic self-learning by understanding a relevant context and adapting to new data. The events associated with the network environment may herein be referred to as “network events.” A network event may refer to any occurrence or change in a state of a network, that is significant enough to be detected, be monitored, and potentially require an action. The action may be associated with a network management operation. The network management operation may refer to a task and/or a process involved in maintaining, monitoring, and optimizing the performance, security, and reliability of the network. The autonomous and collaborative cycle may refer to a cycle or a loop in the AI-driven CNEM system where multiple autonomous AI agents work together in an ongoing, self-regulating process to resolve conflicts, make decisions, and ensure consistency across the AI-driven CNEM system without requiring constant user intervention. Each AI agent can contribute its input, evaluate the network events from its own perspective, and interact with other AI agents to establish a resolution. The collaboration between the AI agents may leverage the roles, strengths, expertise, or reasoning abilities of the different AI agents within the AI-driven CNEM system. In many embodiments, the autonomous and collaborative cycle may include autonomous arbitration corresponding to the network event(s) and/or the network management operation(s), by the AI agents. In a number of embodiments, the AI-driven CNEM system may be AI-native and built on the autonomous and collaborative event arbitration cycle grounded by local context and knowledge. In a variety of embodiments, the AI-driven CNEM system may be configured as an AI-enabled, in-product add-on or as a standalone AI-native solution for network event operations.

Network managers typically face large volumes of network events, for example, device events, data traffic, network incidents, security events, messages, alerts, or the like each day. The sheer volume of the network events can be overwhelming, making it difficult for network managers to analyze and identify meaningful or critical network events. Even with conventional Machine Learning (ML) techniques and predictive analytics, it may be increasingly difficult to properly classify and prioritize the network events, and trigger timely actions. Further, the network managers may face a new level of network events that may have been created or orchestrated by generative AI models. Conventional event management systems may not be able to keep up with demands from current fast moving and complex network operations in the realm of generative AI. Further, as networks become more intricate and dynamic, conventional methods of manual or siloed automation may not be sufficient. Hence, there is a need for a more intelligent, autonomous, and collaborative method for network event management.

The present disclosure addresses the above-mentioned challenges by providing systems and methods for AI-driven CNEM. In various embodiments, the AI agents of the AI-driven CNEM system disclosed herein may operate in a collaborative cycle to analyze and identify meaningful or critical network events. The AI-driven CNEM system receive event information associated with a network environment. The event information may include, for example, contextual information associated with the network environment, knowledge about a domain associated with the network environment, one or more requirements associated with at least one policy corresponding to the network environment, at least one event category indicating a known event type and a meaning of the known event type, at least one event action log associated with the network environment, or the like. By utilizing the AI agents, the AI-driven CNEM system may receive at least one network event, evaluate the network event(s) based on the event information, determine a network management operation based on the evaluation, and trigger at least one action associated with the network management operation. The provision of the event information to the AI-driven CNEM system may implement domain grounding of the AI-driven CNEM system, thereby equipping the AI-driven CNEM system with the right context, data, and understanding to make informed, accurate decisions within a specific domain of the network environment. In more embodiments, in the collaborative cycle, the AI agents may operate collaboratively and iteratively to analyze the network events, perform classifications, evaluate the classifications, generate a relationship graph, traverse or navigate through the relationship graph to identify dependencies and correlations between the network events, prioritize the network events, and trigger actions associated with network management operations. The actions may include, for example, direct changes to devices based on one or more policies corresponding to the network environment, generating alerts, opening a ticket, generating reports, or the like.

In additional embodiments, the AI-driven CNEM system disclosed herein may implement agentic AI, which is a generative AI application, configured to perform decision making, reflection, collaboration, and tool calling for networking use cases. Agentic AI may refer to a probabilistic technology with high adaptability to changing network environments and network events. Agentic AI may rely on patterns and likelihoods to make decisions and trigger actions as opposed to deterministic systems that follow fixed rules and predefined outcomes. Agentic AI may combine new forms of AI, for example, Large Language Models (LLMs), conventional AI such as machine learning, and automation to create autonomous AI agents that can analyze data, set goals, and trigger actions with decreasing human supervision. The AI-driven CNEM system may deploy these AI agents for decision making and dynamic problem-solving, learning, and improving through every interaction.

In further embodiments, the AI-driven CNEM system may perform autonomous arbitration with minimal or no human intervention once the AI-driven CNEM system is tuned for the network environment. In still more embodiments, the AI-driven CNEM system may implement enhanced domain grounding with user-provided context and knowledge. In one or more embodiments, the AI-driven CNEM system may trigger automated actions with recommendations or executions as controlled by the policies. In still further embodiments, the AI-driven CNEM system may execute action dry runs to ensure the actions are rational and can be executed with appropriate network resources. Further, in still additional embodiments, the AI-driven CNEM system may perform continuous self-learning through previous actions and feedback. In some more embodiments, the AI-driven CNEM system may perform personalized reporting of the network events to each user in the network environment.

The AI agents of the AI-driven CNEM system may operate in the collaboration cycle to continuously monitor, filter, analyze, and correlate network events in real time or near-real time, identifying critical network events while reducing noise. In the collaborative cycle, the AI agents may share insights with each other, thereby providing a fast response to emerging issues and reducing the risk of missing critical network events. Moreover, the AI agents can aggregate and analyze the event information from different sources, for example, a local knowledge base, a domain knowledge base, or the like, and operate in tandem to create a unified, comprehensive understanding of the network environment. By sharing data, insights, and recommendations, the AI agents may allow effective monitoring and management of all aspects of the network environment. Further, the AI agents can quickly adapt to changes in dynamic network environments, for example, changes in network configurations, workloads, traffic patterns, or the like, by continuously learning from the event information that may be updated based on feedback, and adjusting their behavior accordingly. For example, when a new network device is added to the network environment, one of the AI agents may automatically adjust its monitoring parameters or configuration to include that network device, and collaborate with the other AI agents to analyze the impact of changes on the network environment and alert users, for example, network administrators, about any risks or performance degradation.

Further, by collaborating and analyzing patterns across large datasets comprising the event information, the AI agents can detect early signs of potential problems such as unusual traffic patterns, security breaches, performance bottlenecks, outages, security vulnerabilities, service degradation, or the like, before these problems escalate into more severe problems. The AI agents may operate in parallel to not only detect the network events but also trigger actions associated with the network management operations, for example, automated remediation, generating alerts, opening tickets, generating reports, escalating to human operators, or the like. Furthermore, by operating in the collaborative cycle, the AI agents may filter out noise and prioritize the alerts, for example, based on severity, impact, and context, to discern which alerts are critical, false positives, or irrelevant. The AI agents can correlate data from different parts of the network environment to reduce false positives, thereby improving the accuracy of the alerts and helping the users to focus on the most critical network events. Further, in yet various embodiments, as network environments scale, and the complexity and volume of network events and changes also increase, the AI agents can scale more easily in a distributed, collaborative setup. Each AI agent can handle specific parts of the network environment. For example, one AI agent may focus on classification of the network events, another AI agent may focus on event correlation, root cause analysis, anomaly analysis, or the like, and another AI agent may focus on reviewing the actions, assessing network resources, or the like. The AI agents can then operate collaboratively to provide comprehensive coverage of the network environment. In yet more embodiments, as network environments are constantly evolving, the AI agents may learn from each other by sharing knowledge and feedback. As the AI agents detect and address network events, the AI agents may continuously refine their ML models, improving their ability to detect future network events and optimize performance, thereby resulting in better automation and more accurate decision-making over time. Furthermore, by pooling insights from multiple AI agents, organizations may obtain a more holistic view of their network's health and performance. The AI agents may collaborate to identify patterns, forecast future issues, and suggest optimal courses of action, thereby aiding in fast and more informed decision-making.

Through the AI agents, the AI-driven CNEM system may allow for collaborative and more efficient monitoring, proactive issue detection, intelligent decision-making, and resource optimization, to maintain high performance, availability, and security in ever-evolving dynamic network environments. By operating in collaboration, the AI agents can handle large volumes of network events, adapt to rapid changes, reduce alert fatigue, and continuously improve network event management capabilities.

Aspects of the present disclosure may be embodied as an apparatus, a system, a method, or a computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. The executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in still yet more embodiments, may alternatively be embodied by or implemented as a component.

A circuit, as used herein, comprises a set of one or more electrical and/or electronic components providing one or more pathways for electric current. In many further embodiments, a circuit may include a return pathway for electric current, so that the circuit is a closed loop. In many additional embodiments, however, a set of components that does not include a return pathway for electric current may be referred to as a circuit (e.g., an open loop). For example, an integrated circuit may be referred to as a circuit regardless of whether the integrated circuit is coupled to ground as a return pathway for electric current or not. In still yet further embodiments, a circuit may include a portion of an integrated circuit, an integrated circuit, a set of integrated circuits, a set of non-integrated electrical and/or electrical components with or without integrated circuit devices, or the like. In still yet additional embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages, or the like) or other discrete electrical devices, in electrical communication with one or more other components through electrical lines of a PCB or the like. Each of the functions and/or modules described herein, in several embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

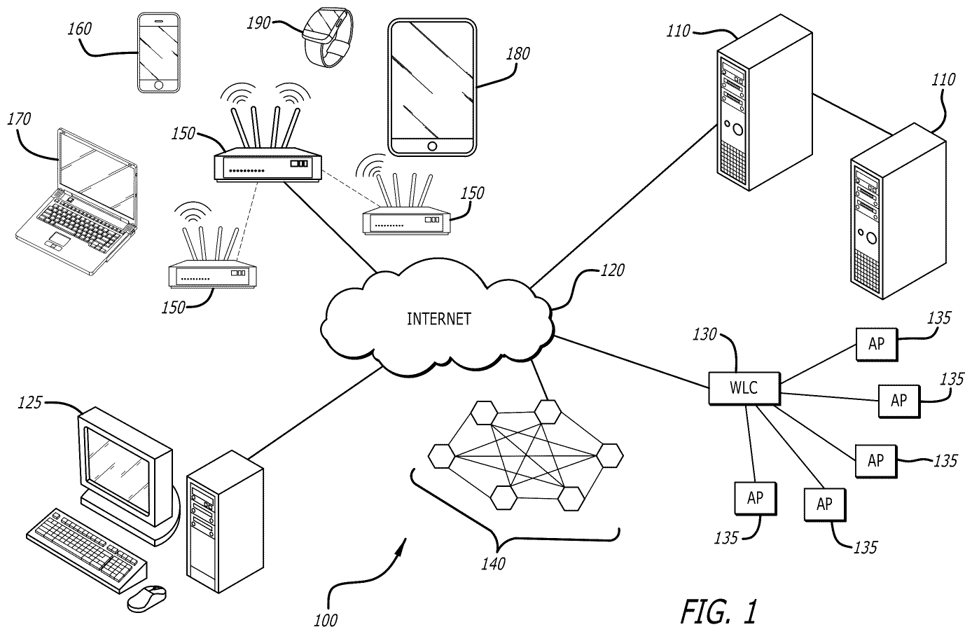

Referring to FIG. 1, a conceptual network diagram 100 of various environments in which a network event management logic may operate on a plurality of network devices in accordance with various embodiments of the disclosure is shown. Those skilled in the art will recognize that the network event management logic can include various hardware and/or software deployments and can be configured in a variety of ways. In many embodiments, the network event management logic can be configured as a standalone device, exist as a logic in another network device, be distributed among various network devices operating in tandem, or be remotely operated as part of a cloud-based network management system. In a number of embodiments, one or more servers 110 can be configured with the network event management logic or can otherwise operate as the network event management logic. In a variety of embodiments, the network event management logic may operate on one or more servers 110 connected to a communication network (shown as the “Internet 120”). The communication network can include wired networks or wireless networks. The network event management logic can be provided as a cloud-based service that can service remote networks, such as, but not limited to, a deployed network 140.

In various embodiments, the network event management logic may be operated as a distributed logic across multiple network devices. In the embodiment depicted in FIG. 1, a plurality of access points 150 can operate as the network event management logic in a distributed manner or may have one specific device operate as the network event management logic for all the neighboring or sibling access points 150. The access points 150 may facilitate Wi-Fi® connections for various electronic devices, such as, but not limited to, mobile computing devices including cellular phones 160, laptop computers 170, portable tablet computers 180, and wearable computing devices 190.

In more embodiments, the network event management logic may be integrated within another network device. In the embodiment depicted in FIG. 1, a Wireless Local Area Network (LAN) Controller (denoted as “WLC”) 130 may have an integrated network event management logic that the WLC 130 can utilize to monitor or control power consumption of a plurality of access points (denoted as “APs”) 135 to which the WLC 130 is connected and manage network events received by the access points 135, via either a wired connection or a wireless connection. In additional embodiments, a personal computer 125 may be utilized to access and/or manage various aspects of the network event management logic, either remotely or within the communication network itself. In the embodiment depicted in FIG. 1, the personal computer 125 communicates over the communication network and can access the network event management logic of the one or more servers 110, or the access points 150, or the WLC 130.

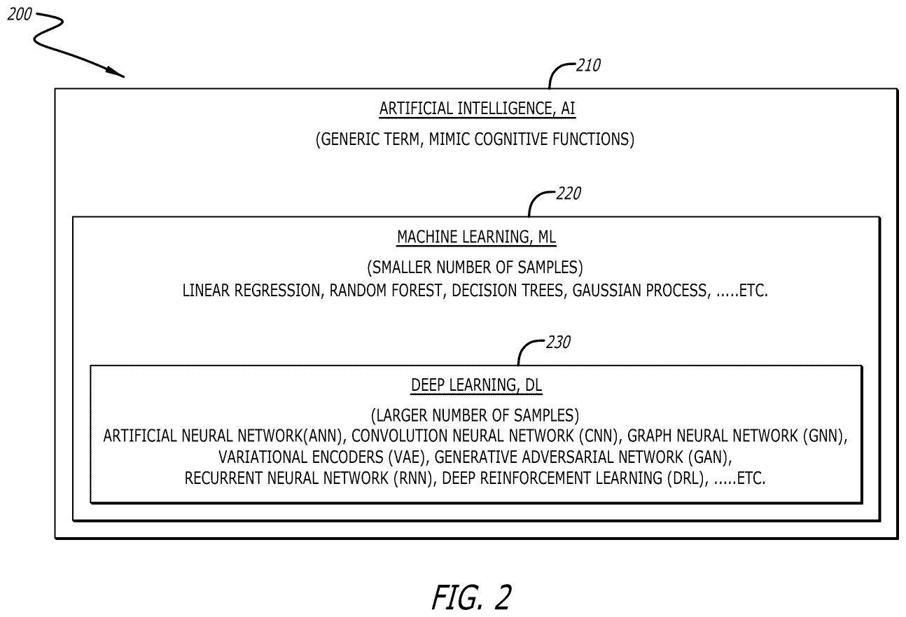

Although a specific embodiment for various environments in which a network event management logic may operate on a plurality of network devices suitable for carrying out the various steps, processes, methods, and operations described herein is discussed with respect to FIG. 1, any of a variety of systems and/or processes may be utilized in accordance with embodiments of the disclosure. For example, the network event management logic may be provided as a device or a software separate from the WLC 130 or the network event management logic may be partially or wholly integrated into the WLC 130. The elements depicted in FIG. 1 may also be interchangeable with other elements of FIGS. 2-12 as required to realize a particularly desired embodiment.

Referring to FIG. 2, a schematic diagram 200 illustrating various subsets of artificial intelligence in accordance with various embodiments of the disclosure is shown. Artificial intelligence (AI) 210 is typically understood in the art to be the development of machines and algorithms that mimic human intelligence, for example, by optimizing actions to achieve certain goals. At its core, AI 210 often involves designing algorithms and models that mimic cognitive functions, such as learning, reasoning, problem-solving, perception, and even language understanding. Unlike conventional computer programs that follow a fixed set of instructions, AI systems can adapt, improve, and make decisions based on input data and environmental interactions.

AI 210 can be considered a generic term because AI 210 encompasses a wide range of subfields and techniques, from simple rule-based systems to advanced machine learning and deep learning models. These AI techniques are utilized for simulating various aspects of human cognition. For example, Machine Learning (ML) 220 allows computers to learn from data patterns without explicit programming for each task, while Natural Language Processing (NLP) enables machines to understand and generate human language. Deep learning (DL) 230, a more advanced branch of AI 210, utilizes neural networks to automatically learn complex patterns from large datasets, akin to information processing by the human brain. This versatility makes AI 210 a powerful tool across diverse applications, including network event classification, anomaly analysis, image recognition, autonomous driving, voice assistants, network diagnostics, and materials discovery.

A goal of AI 210 is often to create systems that can function autonomously and intelligently in real-world scenarios. As AI 210 continues to evolve, AI 210 can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

ML 220 is a subset of AI 210 that focuses on the development of algorithms and statistical models that enable computers to learn and make decisions from data without explicit programming. In conventional programming, a computer is given a fixed set of rules to follow, but ML 220 can shift this paradigm by allowing systems to identify patterns, adapt, and improve their performance based on the data they encounter. This data-driven approach makes ML 220 particularly valuable for tasks that are too complex or dynamic to define using straightforward rules, such as determining patterns associated with network events, recognizing images, predicting consumer behavior, or diagnosing network problems. In various embodiments described herein, machine-learning methods may be utilized for classifying network events, generating relationship graphs, identifying correlations between the network events, and prioritizing the network events.

ML models can be configured to analyze large amounts of data to identify trends and relationships that inform their predictions or classifications. The process typically involves three stages: training, validation, and testing. During training, the ML model learns from a dataset by adjusting its internal parameters to minimize errors between its predictions and the actual results. Techniques such as linear regression, decision trees, random forests, and Gaussian processes are commonly utilized in ML 220. These algorithms can handle various data types, including numerical, categorical, and structured datasets such as spreadsheets or grids. One of the strengths of ML 220 is its ability to generalize from training data to make accurate predictions on new, unseen data. In many embodiments described herein, training data may be generated from event information received from multiple sources, for example, a local knowledge base, a domain knowledge base, among other sources.

However, conventional ML methods may rely heavily on feature engineering, wherein human experts manually identify the most relevant features or patterns within the data. For example, when using ML 220 for classifying network events, an expert may need to extract features such as header characteristics, payload characteristics, temporal characteristics, protocol type, packet count, context, domain, connection states, or the like, before feeding them into the ML model. This requirement can limit the scalability of conventional ML approaches, especially when dealing with large, unstructured datasets such as images, text, or graphs. Additionally, ML algorithms may often work best when provided with relatively structured data, and they often need a reasonable number of samples (typically more than 100) to learn effectively.

DL 230 is a specialized subset of ML 220 that employs multi-layered artificial neural networks to automatically learn complex patterns and representations from large, often unstructured datasets. Inspired by the way the human brain processes information, DL 230 includes interconnected layers of “neurons” that can adaptively change as they are exposed to more data. Unlike conventional ML methods, which require manual feature engineering to identify data characteristics, DL models can automatically extract features directly from raw data, such as images, text, or data structures. This automated feature extraction allows DL 230 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as network traffic, network structures, atomic interactions, loads, or the like. GNNs can learn the dependencies and relationships within graph-like structures, which may facilitate predicting properties of complex patterns, network traffic, and materials. For example, the features of the network events are modeled as a graph and may be input into a GNN for classifying the network events as normal or legitimate network events, critical network events, or anomalous network events. By organizing the features of the network events into a graph structure, situations where new or unseen patterns generated by newly developed or updated applications, referred to as “zero-day” applications, are unknown, may be handled optimally. RNNs and their variants, such as Long Short-Term Memory (LSTM) networks, are suited for sequential data such as time series or NLP, allowing for the analysis and generation of textual information or the prediction of temporal patterns in scientific research.

One of the defining characteristics of DL 230 is its requirement for large datasets (typically over 500 samples for example) to effectively train neural networks. While the deep, multi-layered structure of these networks enables them to capture highly complex and abstract representations of the data, they also demand significant computational power. Techniques such as Variational Autoencoders (VAEs) and Generative Adversarial Networks (GANs) add to the versatility of DL 230 by enabling the generation of new data samples that resemble a training dataset, aiding in areas such as materials discovery and synthetic data creation. Deep Reinforcement Learning (DRL) combines neural networks with decision-making processes to solve problems that involve optimization and control, further expanding the application potential of DL 230. In summary, the ability of DL 230 to automatically learn from raw, unstructured data and model intricate patterns makes DL 230 a powerful tool in AI 210, particularly for complex domains such as image recognition, NLP, and materials science.

Artificial Neural Networks (ANNs or sometimes merely NNs) are often a foundation of a DL system. The basic unit of a neural network is typically a perceptron, which can take inputs, assigns weights to these inputs, and combines them to produce an output. The final output is then passed through an activation function, for example, a Rectified Linear Unit (ReLU), a sigmoid, or a hyperbolic tangent, to introduce non-linearity, which enables the network to model complex patterns.

Neural networks are typically trained through a process of backpropagation, where predictions of an AI system are compared against a known output, and a loss function is utilized to measure the difference between the prediction and the actual result. The weights assigned by the neural network can be adjusted through a process called gradient descent, which can be configured to minimize the loss function over time. However, the training process can be prone to problems such as overfitting (where the ML model performs well on the training data but poorly on new data). To counter this, techniques such as regularization (e.g., dropout), early stopping, and mini-batches can be utilized to prevent the neural network from becoming overly specialized to the training dataset.

CNNs are a specific type of ML neural network designed to work particularly well with network data, making them highly relevant for classifying network events, which may be subject to processing. As those skilled in the art will recognize, CNNs typically utilize specialized layers known as convolutional layers, which apply filters (also known as kernels) to the input data. These filters slide over the input (e.g., an input power value), detecting patterns such as edges or textures, which are then passed to the next layer for further processing. CNNs can automatically learn and extract relevant features from raw data without the need for manual feature engineering. Furthermore, pooling layers (e.g., max-pooling or average pooling) are often added after convolutional layers to reduce the dimensionality of the data, helping to make the AI system more efficient while retaining the most important information. After several layers of convolutions and pooling, the CNN can output a prediction, such as whether the network event is normal, critical, or anomalous.

While CNNs are well-suited for grid-based data like images, many real-world problems can involve non-grid data, such as event logs, alerts, or the like. This type of data may better be represented as a graph, where nodes represent entities (e.g., network devices, Internet Protocol “IP” addresses, applications, or the like) and edges represent relationships between them (e.g., communication patterns or data flows between the network devices and the applications). Thus, Graph Neural Networks (GNNs) can be utilized to operate on such graph-based data.

In GNNs, information is passed between the nodes through the edges in a process called message passing. This allows the neural network to capture dependencies and relationships within the graph structure. GNNs can aggregate information from neighboring nodes, which is utilized in predicting properties that depend on the current/local structure, such as the behavior of the applications or the properties of the network devices.

Generative models aim to learn the underlying distribution of a dataset and generate new samples that resemble the original data. Two common types of generative models are VAEs and GANs. VAEs are often configured to work by encoding data into a lower-dimensional latent space and then decoding the data back into its original form, which allows for the generation of new data by sampling points from the latent space. This can be utilized when attempting to construct a graph based on features of the network events and the network devices or applications. Similarly, GANs include two components: a generator that creates fake or generated data and a discriminator that attempts to distinguish between real data and fake data. The two components are trained in a competitive process where the generator attempts to “fool” the discriminator, leading to increasingly realistic generated data. This type of process may be utilized to produce synthetic samples that resemble the training data, which can help augment the training dataset.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as images or complex network event simulations.

In network event classification, DRL can be utilized in scenarios where an optimal decision needs to be made, such as classifying the network events as normal network events, critical network events, anomalous network events, or the like based on various features such as packet headers, data flow characteristics, context, domain, etc. The combination of RL and DL 230 can allow for learning from raw data, making it a powerful tool for dynamic and real-time decision-making for network event classification.

Although a specific embodiment for various subsets of artificial intelligence suitable for carrying out the various steps, processes, methods, and operations described herein is discussed with respect to FIG. 2, any of a variety of systems and/or processes may be utilized in accordance with embodiments of the disclosure. For example, another subset such as transformer networks, capsule networks, or the like may be present and available for use within AI 210. Those skilled in the art will recognize that the schematic diagram 200 presented in FIG. 2 is simplified for illustration purposes and various methods and techniques may interact with other areas (ML 220 with DL 230, etc.). The elements depicted in FIG. 2 may also be interchangeable with other elements of FIG. 1 and FIGS. 3-12 as required to realize a particularly desired embodiment.

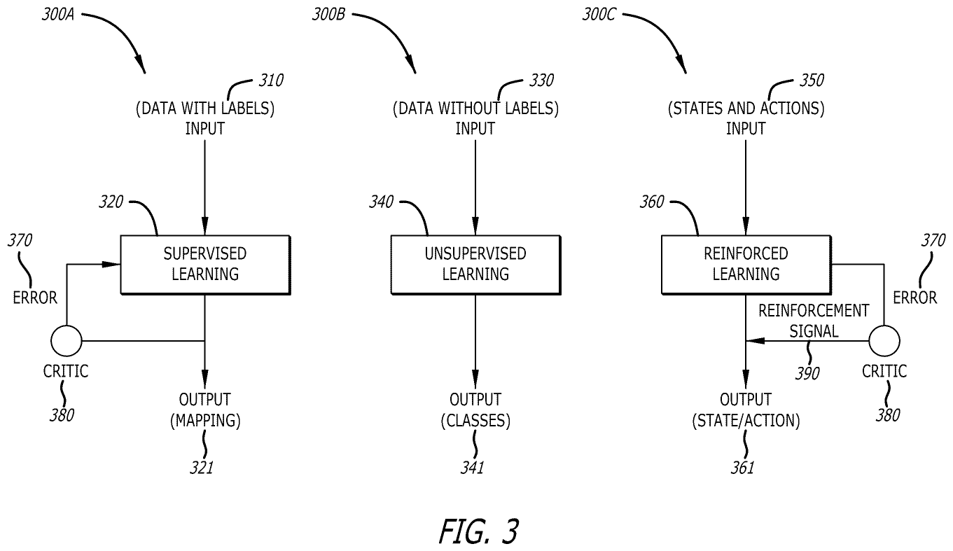

Referring to FIG. 3, a block diagram illustrating different methods of machine-based learning in accordance with various embodiments of the disclosure is shown. In many embodiments, an ML model is defined as a mathematical representation of an output of a training process. An ML model is often considered similar to computer software designed to recognize patterns or behaviors based on previous experience or data. An ML algorithm can discover patterns within training data, and output an ML model which can capture these patterns and make predictions on new data.

ML models may be interpreted as devices that have been trained to find patterns within new data and make predictions. These ML models can be represented as complex mathematical functions that would be impractical for a human to calculate, that takes requests in the form of input data, makes predictions on input data, and then provides an output in response. These ML models can be trained over a set of data, and then they may be provided an algorithm or other task to reason over the data, extract patterns from feed data, and learn from that data. Once the ML models are trained, they can be utilized to predict a new and previously unseen dataset.

There are various types of ML models available based on different business goals and datasets available. Often, based on the desired application, ML models can be configured as or settled into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 3, a supervised learning system 300A is shown. The supervised learning system 300A can be configured with a supervised learning model 320 that accepts input data 310 and generates output data 321. The output data 321 is often reviewed by a critic 380 that can determine an error 370 that is fed back into the supervised learning model 320 for use in updating.

Supervised learning systems 300A are often considered the simplest ML model to understand which input data (such as training data) has a known label or result as an output. The supervised learning model 320 can, therefore, be understood to work on the principle of input-output pairs. As such, a function can be trained using a training dataset, which is then applied to unknown data to make some predictions. Supervised learning is task-based and mostly tested on labeled datasets.

Supervised learning systems 300A may often involve one or more regression problems. In regression problems, the output is a continuous variable. Examples of commonly utilized regression models include linear regression, decision trees, and random forests. Linear regression is typically the most straightforward ML model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this linear equation may be represented in the form of a line: y=bx+c. A typical aim of a linear regression-based model can be to find an optimal fit line that best fits available data points. Linear regression can be extended to multiple linear regressions (finding a plane of best fit in a higher dimensional space) and polynomial regressions (finding the best fit curve). Decision trees are also popular ML models that can be utilized for both regression and classification problems. A decision tree utilizes a tree-like structure of decisions along with their possible consequences and outcomes. In a decision tree, each internal node is utilized to represent a test on an attribute while each branch is utilized to represent the outcome of the test. The more nodes a decision tree has, the more accurate the result will be. This may be utilized when making decisions related to network events and their separation. Decision trees are intuitive and easy to implement, but may lack accuracy depending on computational or time resources available.

Random forests are an ensemble learning method, which may include a large number of decision trees. For example, each decision tree in a random forest predicts an outcome, and the prediction with a majority of votes is considered as the outcome. A random forest model can be utilized for both regression and classification problems. For a classification task, the outcome of the random forest may be taken from the majority of votes. Whereas in a regression task, the outcome can be taken from a mean or an average of the predictions generated by each tree.

Classification models are the other type of supervised learning, which can be utilized for generating conclusions from observed values in one or more categorical forms. For example, a classification model can identify if an email is spam or not; whether network events are normal, critical, or anomalous, etc. Classification algorithms can also be utilized for predicting between two or more classes and/or categorize an output into different groups. For these classification systems, a classification model can be designed that classifies a dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be utilized for solving various classification problems in machine learning systems. These processes are similar to linear regression but are often utilized for predicting categorical variables. While some variations can be configured to generate a prediction as an output in either “yes” or “no,” 0 or 1, “true” or “false,” etc., in a number of embodiments, the system can instead be configured to not give exact values, but instead provide probabilistic values between zero and one.

Another classification process that can be utilized is a Support Vector Machine (SVM) which is widely utilized for classification and regression tasks. However, the main aim of the SVM is to find the best decision boundaries in an N-dimensional space, which can be utilized for segregating data points into classes, and generate a best decision boundary often known as a hyperplane. SVM processes can select an extreme vector to find a hyperplane, wherein this vector is known as a support vector.

Naïve Bayes is another popular classification algorithm utilized in machine learning. This classification process is based on Bayes' theorem and follows a naïve (independent) assumption between features which is often based on the following formula:

$$P ( y \vert X ) = \frac{P ( X \vert y ) * P ( y )}{P ( X )}$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as a posterior chance being a result of prior results times the likelihood divided by evidence available. Each Naïve Bayes classifier assumes that the value of a specific variable is independent of any other variable/feature. For example, if a fruit needs to be classified based on color, shape, and taste, yellow, oval, and sweet will be recognized as mango. In this example, each feature is independent of other features. Likewise, various embodiments herein can classify the network events into categories such as authentication events, access control events, security events, or the like, which may constitute normal network events, critical network events, or anomalous network events.

Further, in the embodiment depicted in FIG. 3, an unsupervised learning system 300B is shown. The unsupervised learning system 300B can be configured with an unsupervised learning model 340 that accepts input data 330 and generates an output 341. Unlike other model types, there are no critics or error signals to process. Unsupervised learning models 340 can implement a learning process opposite to supervised learning, which means the learning process enables a model to learn from an unlabeled training dataset. Based on the unlabeled training dataset, the unsupervised learning model 340 can predict the output 341. Using the unsupervised learning system 300B, the unsupervised learning model 340 can learn hidden patterns from the unlabeled training dataset by itself without any supervision. In a variety of embodiments, unsupervised learning models 340 are often utilized for performing tasks involving clustering, association rule learning, and/or dimensional reduction.

Clustering is an unsupervised learning technique that involves clustering or grouping the available data points into different clusters based on similarities and/or differences. The data points or objects with the most similarities remain in the same group, and they have no or very few similarities from other groups. Clustering algorithms can be utilized in various tasks such as, but not limited to, image segmentation, statistical data analysis, market segmentation, or the like. Some commonly utilized clustering algorithms that can be selected include, for example, K-means clustering, hierarchal clustering, Density-based Spatial Clustering of Applications with Noise (DBSCAN), etc.

Association rule learning is an unsupervised learning technique which finds unique relations among variables within a large dataset. In various embodiments, a primary aim of this type of learning algorithm is to find a dependency of one data item on another data item and map those variables accordingly to satisfy a desired outcome. For example, in more embodiments, an association rule system may be utilized for identifying relationships between different types of network events and classifying the network events. This learning algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and Frequent Pattern (FP)-growth algorithm.

In additional embodiments, the number of features/variables present in a dataset can be understood as the dimensionality of the dataset, and the technique utilized to reduce the dimensionality is known as a dimensionality reduction technique. Although more data provides more accurate results, more data can also affect the performance of the model/algorithm, for example, by yielding overfitting outcomes. In such cases, dimensionality reduction techniques can be utilized. Dimensionality reduction techniques involve converting a higher-dimensional dataset into a lower-dimensional dataset while also ensuring that the ensuing results provide similar information. Different dimensionality reduction methods can be utilized, such as, but not limited to, Principal Component Analysis (PCA), Singular Value Decomposition (SVD), etc.

Further, in the embodiment depicted in FIG. 3, a reinforcement learning system 300C is shown. The reinforcement learning system 300C can be configured with a reinforcement learning model 360 that accepts input data 350 and generates an output 361. In reinforcement learning, the reinforcement learning model 360 learns actions for a given set of states that lead to a goal state. In the embodiment depicted in FIG. 3, a critic 380 can receive or otherwise notice an error 370 within the reinforcement learning model 360 actions, and transmit a reinforcement signal 390 to adjust the outcome/output such that the “reward” or “punishment” is adjusted to better model the future behaviors or processing of the reinforcement learning model 360.

The reinforcement learning model 360 is a feedback-based learning model that can take feedback signals after each state or action by interacting with the environment. This feedback works as a reward (positive for each good action and negative for each bad action), and an AI agent's goal is to maximize the positive rewards to improve their performance. The behavior of the reinforcement learning model 360 in reinforcement learning is similar to that of human learning, as humans learn things by experiences as feedback and interact with an environment. Popular methods of reinforcement learning including Q-learning, State-Action-Reward-State-Action (SARSA), and deep Q network.

Q-learning is one of the popular model-free algorithms of reinforcement learning, which is based on the Bellman equation. Q-learning often aims to learn a policy that can help an AI agent to take the best action for maximizing a reward under a specific circumstance. Q-learning can incorporate a Q-value for each state-action pair that indicates the reward to following a given state path, and tries to maximize that Q-value.

SARSA is an on-policy algorithm based on the Markov decision process. In further embodiments, SARSA can use the action performed by the current policy to learn the Q-value. The SARSA algorithm stands for State Action Reward State Action, which symbolizes the tuple (s, a, r, s′, a′). A Deep Q-Network (or DQN) implements Q-learning within a neural network. The DQN can be deployed within a big state space environment where defining a Q-table would be a complex task. In these embodiments, rather than using a Q-table, the DQN utilizes Q-values for each action based on the state.

Although a specific embodiment for different methods of machine-based learning suitable for carrying out the various steps, processes, methods, and operations described herein is discussed with respect to FIG. 3, any of a variety of systems and/or processes may be utilized in accordance with various embodiments of the disclosure. For example, those skilled in the art will recognize that methods of learning described herein are generalized and may incorporate other types developed as well as a combination of one or more methods based on the goals of the desired application. The elements depicted in FIG. 3 may also be interchangeable with other elements of FIGS. 1-2 and FIGS. 4-12 as required to realize a particularly desired embodiment.

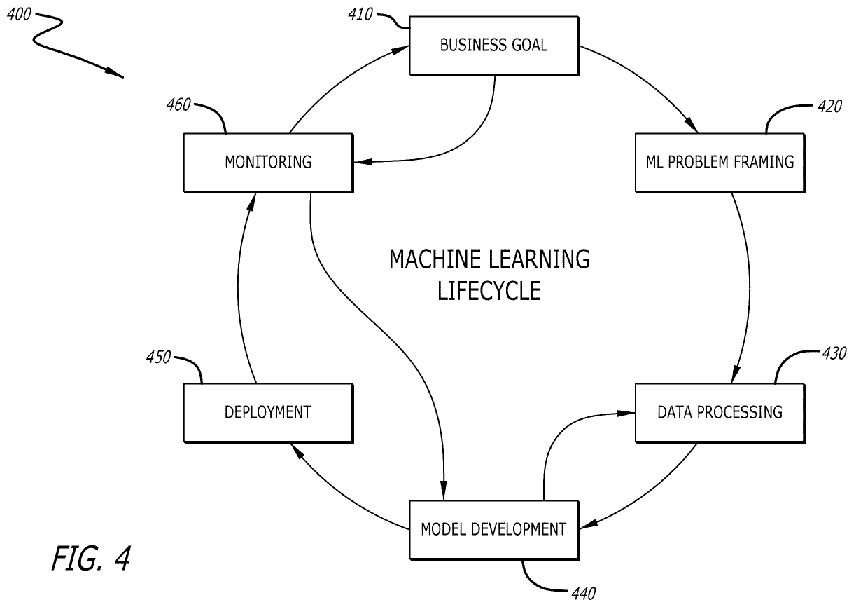

Referring to FIG. 4, a block diagram illustrating a machine learning lifecycle 400 in accordance with various embodiments of the disclosure is shown. While developing machine learning systems, the embodiment depicted in FIG. 4 can provide a framework for structuring the design and maintenance of these machine learning systems. The machine learning lifecycle 400 outlines various stages involved in building, deploying, and improving ML models to solve real-world problems. By following this structured process, businesses and organizations can ensure that their ML projects align with strategic goals, utilize data effectively, and adapt to changing conditions over time. This machine learning lifecycle 400 emphasizes that developing an ML model is not a one-time effort but an iterative process requiring ongoing monitoring and adjustment. A feedback loop inherent in the machine learning lifecycle 400 allows for continual refinement and optimization of the ML models to maintain their accuracy and relevance.

In many embodiments, a first stage of the machine learning lifecycle 400 includes identifying a business goal 410, which sets an overall direction and purpose for an ML project. Identifying the business goal 410 can involve understanding specific problems or opportunities within a business or a project that machine learning can address. A clear business goal 410 ensures that the project remains focused on delivering tangible value, whether it is classifying different types of network events or distinguishing between normal network events, critical network events, and anomalous network events. Without a well-defined business goal 410, it can be challenging to align subsequent stages of the machine learning lifecycle 400, as the choice of model, data processing methods, and performance metrics can all depend on what the business aims to achieve.

Establishing a proper business goal 410 can also involve engaging with key stakeholders and developers to gather requirements and set success criteria, which can provide a roadmap that outlines what success looks like and helps in framing an ML problem. For example, if the goal is to classify network events as normal network events, critical network events, or anomalous network events, the project may focus on developing an ML model that utilizes event information received from a local knowledge base or a domain knowledge base as input for distinguishing between normal network events, critical network events, and anomalous network events in a network environment. Clearly defined business goals not only help guide the project but also provide benchmarks for evaluating the effectiveness of the deployed ML model once the deployed ML model enters production.

Once the business goal 410 is established, various embodiments take a next step involving ML problem framing 420, wherein the business goal 410 is translated into a specific machine learning task. This can involve selecting the appropriate type of ML problem, such as classification, regression, clustering, or recommendation, and defining target variables or outputs. For example, if the business goal 410 is to classify network events as normal network events, critical network events, or anomalous network events, the problem can be framed as a regression task where the ML model treats features of at least one network event such as packet header information, payload characteristics, temporal patterns, protocol type, or the like as variables and a severity score as a metric for detecting critical or anomalous events and associated network management operations. Proper ML problem framing 420 determines particular data requirements, choice of model, and evaluation metrics.

During the stage of ML problem framing 420, it is also prudent to consider constraints and assumptions that may affect the development of the ML model. The constraints and assumptions may include, for example, data availability, computational resources, ethical considerations, or regulatory compliance. Properly framing the ML problem ensures that the development of the ML model aligns with the needs of the business and that the ML problem is broken down into manageable steps, ultimately increasing the project's chances of success.

Data processing 430 is a stage in many embodiments where raw data is collected, cleaned, and transformed into a format suitable for machine learning. This stage of the machine learning lifecycle 400 can involve gathering data from various sources, removing errors or inconsistencies, handling missing values, and normalizing or scaling features to ensure that the ML model can learn effectively. Feature engineering is often a part of this stage, where new features are derived from the raw data to capture more relevant information and improve model performance.

The quality and preparation of the utilized data can significantly impact the accuracy and reliability of the ML model. Inadequate or poorly processed data can lead to biased or inaccurate predictions, no matter how advanced the ML model is. Hence, data processing 430 can require or at least benefit from careful planning and iterative refinement. Once the data is processed, the data is typically split into training, validation, and test datasets to develop and evaluate the ML model, ensuring that the ML model generalizes well to new, unseen data.

Model development 440 is a stage, in a number of embodiments, where machine learning algorithms are selected, trained, and refined to create an ML model that addresses the framed problem. This stage can involve choosing an appropriate algorithm (e.g., decision trees, neural networks, support vector machines, or the like), setting up the architecture of the ML model, and defining hyperparameters that will guide the training process. The ML model is trained on the processed data to identify patterns and relationships that allow the ML model to make predictions or decisions.

During model development 440, the ML model can be evaluated using the validation dataset to finetune its parameters and improve performance. Techniques such as cross-validation, regularization, and hyperparameter tuning can be utilized to prevent overfitting and ensure the ML model generalizes well. If proper steps are taken, the result is an ML model that, once the ML model meets predefined performance metrics, is ready for deployment in a real-world environment. However, model development 440 often involves several iterations to optimize the ML model for the specific business goal, indicated by an arrow directed back to data processing 430.

In a variety of embodiments, deployment 450 is the stage of the machine learning lifecycle 400 where the developed ML model is integrated into a production environment to perform its intended tasks. This stage may involve setting up necessary infrastructure, such as Application Programming Interfaces (APIs) or cloud-based services, to allow the ML model(s) to process live data and generate predictions. Deployment 450 can transform the ML model from a research tool into a functional component of a business process or product, providing real-time insights, automations, or decisions.

Proper deployment 450 can also include setting up mechanisms for logging, error handling, and user access. Since real-world environments are often dynamic and differ from training conditions, deployment 450 may require continuous adaptation and updates to ensure the ML model(s) operates efficiently. This stage may define the success of the ML model because the ML model's success is not only determined by its performance metrics but also by its ability to provide actionable results that align with the business goal 410.

In various embodiments, monitoring 460 is an ongoing process of tracking the performance and behavior of the ML model after deployment 450. Monitoring 460 involves collecting data on the ML model's predictions, accuracy, latency, and error rates to detect issues such as concept drift, where changes in the underlying data patterns can degrade the accuracy of the ML model. By continuously monitoring 460, teams can identify when the performance of the ML model drops and requires retraining or adjustments to align with evolving data.

Monitoring 460 can also encompass aspects such as user feedback, security, and compliance, ensuring that the ML model remains effective, reliable, and ethical in its application. Monitoring 460 may serve as a feedback loop in the machine learning lifecycle 400, where insights gained from monitoring feedback into the earlier stages of the machine learning lifecycle 400, particularly data processing 430 and model development 440, to refine the ML model(s) as needed. This iterative process allows a machine learning system to adapt and maintain its alignment with the original business goal 410 over time.

Although a specific embodiment for a machine learning lifecycle 400 suitable for carrying out the various steps, processes, methods, and operations described herein is discussed with respect to FIG. 4, any of a variety of systems and/or processes may be utilized in accordance with embodiments of the disclosure. For example, the particular route of development of the ML model(s) may not follow this machine learning lifecycle 400 completely. As those skilled in the art will recognize, there are a variety of ways to develop AI products that include various iterative steps that aid in development and refinement of different ML models. The elements depicted in FIG. 4 may also be interchangeable with other elements of FIGS. 1-3 and FIGS. 5-12 as required to realize a particularly desired embodiment.

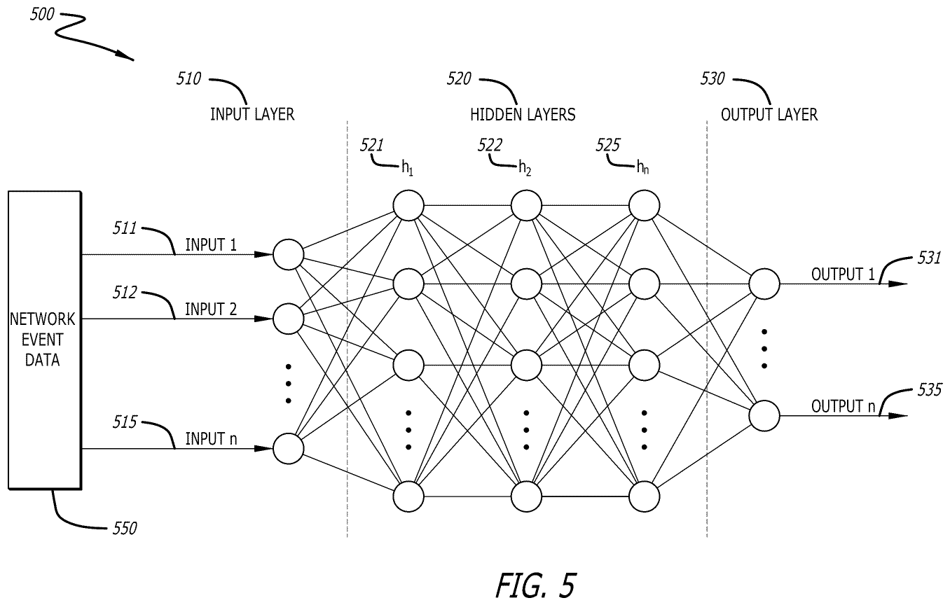

Referring to FIG. 5, a schematic diagram illustrating an example neural network 500 in accordance with various embodiments of the disclosure is shown. The embodiment illustrated in FIG. 5 specifically depicts a feedforward neural network with multiple layers. This type of network includes an input layer 510, one or more hidden layers 520, and an output layer 530. Each layer contains nodes (or neurons) that are interconnected, representing how data flows through the feedforward neural network. The input layer 510 can receive raw network event data 550, which is then processed by the hidden layers 520 through weighted connections and activation functions. These hidden layers 520 can enable the feedforward neural network to learn complex patterns and relationships within the network event data 550.

The final output layer 530 produces predictions or classifications of the feedforward neural network based on the processed network event data. The interconnected nature of the nodes allows the neural network 500 to learn from the network event data 550 during training by adjusting weights of connections to minimize prediction errors. This structure is the foundation of deep learning models, as adding more hidden layers 520 can create a deep neural network, capable of tackling highly complex tasks such as image recognition, NLP, and pattern detection in large datasets.

A perceptron or a single artificial neuron is the building block of ANNs and can perform forward propagation of information. For a set of inputs to the perceptron, weights (and biases to shift weights) can be assigned. These inputs and weights can be multiplied out correspondingly together to obtain a sum output. Those skilled in the art may recognize tools such as, but not limited to, PyTorch, Tensorflow, and MXNet as training packages for common neural network tasks. However, it is contemplated that other tools may be developed specifically for the neural network tasks related to the embodiments described herein.

In many embodiments, weight matrices of the neural network 500 can be initialized randomly or obtained from a pre-trained model. These weight matrices can be multiplied with the input matrix (or output from a previous layer) and subjected to a nonlinear activation function to yield updated representations, which are often referred to as activations or feature maps. A loss function (also known as an objective function or empirical risk) can often be calculated by comparing the output of the neural network 500 and known target value data.

Feedforward networks, such as the neural network 500 depicted in the embodiment of FIG. 5, are often configured as neural networks where information moves in one direction, from the input layer 510 through the hidden layers 520 to the output layer 530, without any cycles or loops. The feedforward networks are primarily utilized for tasks such as classification, regression, and simple pattern recognition, where each input is processed independently of others. In contrast, backpropagation is not a separate type of network but rather a training algorithm commonly utilized in both feedforward and other types of networks such as Recurrent Neural Networks (RNNs).

Backpropagation involves adjusting the weights of the neural network in a reverse direction (from output to input) based on an error between a predicted output and an actual target during training. While feedforward describes the structure and data flow within the neural network, backpropagation is a technique utilized to optimize the model. Feedforward networks are utilized for straightforward tasks where input-output relationships are not sequential or time-dependent. However, for problems involving learning complex patterns over time, such as speech recognition or time-series analysis, neural networks that leverage backpropagation for training such as RNNs or deep feedforward networks with many hidden layers, become necessary to capture these intricate dependencies.

Typically, in these network arrangements, the weights are iteratively updated via various methods including, but not limited to, stochastic gradient descent algorithms to help minimize the loss function until a desired accuracy is achieved. Most modern deep learning frameworks can facilitate this iterative update by using reverse-mode automatic differentiation to obtain partial derivatives of the loss function with respect to each network parameter through recursive application of a chain rule. Colloquially, this is also known as backpropagation. Common gradient descent algorithms can include, but are not limited to, Stochastic Gradient Descent (SGD), Adam, Adagrad, etc. Learning rate is one of the parameters in gradient descent. Except for SGD, all other methods utilize adaptive learning parameter tuning. Depending on the objective such as classification or regression, different loss functions such as Binary Cross Entropy (BCE), Negative Log Likelihood Loss (NLLL), or Mean Squared Error (MSE) can be utilized.

Neural network architecture is commonly utilized for a wide range of tasks in fields such as computer vision, NLP, financial forecasting, and materials science. For instance, the neural network architecture can be employed to recognize patterns in images such as identifying objects or faces, or to classify text into categories such as anomaly detection in the network event data or network event classification. The neural network architecture is also useful in regression problems, such as predicting stock prices or energy consumption, where input features can be processed to output continuous values. However, this is a general example of an AI model, illustrating how a feedforward neural network works. Depending on the problem, other methods and models may be more appropriate. For example, CNNs are often utilized for image processing tasks, while RNNs are suitable for sequential data such as time series data or text. Additionally, simpler models such as linear regression, decision trees, or SVMs may be sufficient if the problem is less complex, or a dataset is relatively small. The embodiment depicted in FIG. 5 is presented as an example ML solution that may be deployed within one or more methods or systems described herein.

In a number of embodiments, the input layer 510 is the first layer in the neural network 500 and serves as the initial point where raw network event data 550 is introduced into the model. Each node (or neuron) in this input layer 510 represents an individual feature or variable from the dataset, allowing the neural network 500 to receive and process various types of data, such as features in the network event data 550, pixel values in an image, numerical features in a spreadsheet, or words in a text document. For instance, in image recognition tasks, the input layer 510 can include nodes that correspond to pixel values of the image, providing the neural network 500 with visual information needed to identify objects or patterns. The number of nodes in the input layer 510 directly depends on the number of features present in the dataset. If there are one hundred features in the network event data 550, the input layer 510 will typically have one hundred nodes, each conveying one piece of the information to the subsequent layers. In a variety of embodiments, the inputs of the neural network 500 are generally scaled, that is, normalized to have a zero mean and/or a unit standard deviation. Scaling can also be applied to the input of the hidden layers 520, for example, by utilizing batch or layer normalization to improve the stability of the neural network 500.

Unlike the hidden layers 520 and the output layer 530, the input layer 510 typically does not perform any computations or transformations on the data. The primary function of the input layer 510 is often to pass the input data to the next layer in the neural network 500, that is, the first hidden layer 521. However, it is often desired that the data fed into this hidden layer 521 is preprocessed appropriately, such as being normalized or standardized, to ensure that the neural network 500 can learn efficiently. Proper preprocessing, for example, scaling numerical values or encoding categorical variables, can help the neural network 500 process data uniformly, facilitating more stable and faster convergence during training.

The design of the input layer 510 depends on the nature of the problem. For example, in NLP, the input layer 510 may represent words encoded as numerical vectors, while in time series analysis, each node may represent a data point in a sequence. While the input layer 510 itself does not modify the data, the input layer 510 sets the stage for the neural network 500 to extract complex patterns and relationships through the deeper layers. This flexibility in handling various types of input make the neural network 500 a powerful tool for a diverse set of applications.

With respect to the embodiments described herein, the input layer 510 may be configured with a plurality of inputs providing network event data 550. For example, the ML model can be configured with a first input 511 configured as packet header characteristics, a second input 512 configured with payload characteristics, while additional inputs can be added related to temporal characteristics associated with the network event data 550. The nth input 515 can be configured in various embodiments to include state transition characteristics associated with network traffic. However, as those skilled in the art will recognize, additional setups can be configured such that the inputs 511, 512, and 515 can be configured to also include different parameters such as IP addresses, one or more port numbers, packet sizes, one or more protocol types, one or more timestamps, one or more bytes of a payload, event types, weights, etc.

In more embodiments, the neural network 500 comprises a plurality of hidden layers 520. The embodiment depicted in FIG. 5 comprises a first hidden layer 521, a second hidden layer 522, and an nth hidden layer 525, which are denoted as h₁, h₂, and hₙ, respectively. In additional embodiments, the hidden layers 520 are disposed where the core of the ML model's learning and pattern recognition occurs. In each of the hidden layers 520, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the neural network 500 to capture complex patterns in the data that simple linear models cannot. The intricate web of connections among neurons across layers helps the neural network 500 transform and process input features into representations that become progressively more abstract and useful for making predictions.

The first hidden layer 521, h₁, receives direct input from the input layer 510, transforming the raw network event data 550 into an initial set of features. For example, in a network event classification task, the first hidden layer 521 may initiate identifying patterns in basic statistical features such as flow duration, packet size, number of packets, inter-arrival times, or the like; detecting outliers or instances that deviate substantially from the rest of the training data such as unexpected protocol transitions, unusual spikes in the network traffic, unexpected state transitions in communication protocols; or the like. The output of the first hidden layer 521 is then passed to the second hidden layer 522, h₂, which builds upon the features identified by the first hidden layer 521. This deeper hidden layer 522 may start recognizing more complex patterns, such as large packet sizes with short flow durations, frequent transitions between different protocols, repeated bursts of network traffic across multiple time windows, unusual time patterns in the flow of packets, or the like, by combining the lower-level features identified in the previous hidden layer. This can continue until a last, nth hidden layer 525, hₙ, continues this abstraction process, allowing the neural network 500 to recognize even higher-level, more detailed features, such as identifying a combination of multiple protocol transitions over time that indicate a multi-stage attack, for example, Man-in-the-Middle (MitM) attacks, Advanced Persistent Threats (APTs), or the like, or understanding intricate relationships in the input network event data 550. With respect to the embodiments described herein, the hidden layers 520 may learn one or more patterns of the input network event data 550 to extract higher-level features from the raw network event data 550, thereby improving the ability of the ML model to distinguish between normal network events, critical network events, or anomalous network events.

Each of the hidden layers 520 adds a level of complexity and abstraction to the learning capabilities of the neural network 500. The multi-layer structure can enable the neural network 500 to move from recognizing simple patterns in the first hidden layer 521 to highly complex, abstract concepts in the deeper hidden layers. The number of hidden layers 520 and neurons within them can vary depending on the complexity of the problem. More hidden layers 520 generally allow the neural network 500 to model more intricate functions, making deep neural networks especially effective for tasks such as image recognition, NLP, anomaly detection, and complex predictive modeling. However, adding more layers also increases the computational demand and the risk of overfitting, highlighting the need to carefully design and tune these hidden layers 520 for optimal performance.

In further embodiments, the output layer 530 is often the final layer in the neural network 500 and is responsible for producing predictions or classifications of the neural network 500 based on the information processed through the previous hidden layers 520. Each neuron in the output layer 530 can represent a specific outcome or category that the ML model can predict. In the embodiment depicted in FIG. 5, the outputs are labeled as “output 1” 531 to “output n” 535, indicating that the neural network 500 can be designed to have a varying number of outputs depending on the nature of the problem being solved. For example, in a binary classification (e.g., normal events versus anomalous events), there would typically be a single output neuron that provides a probability score for one of the two classes/outcomes. In contrast, for multi-class classification (e.g., categorizing network events into different types based on protocols utilized in communications), the output layer 530 would contain multiple neurons, each corresponding to a different class.

The number of neurons in the output layer 530 can also be designed specifically for other types of tasks, such as regression, where the ML model can predict continuous values. In such cases, the output layer 530 may contain a single neuron representing a numerical prediction, such as a price of a house or a temperature forecast, etc. Alternatively, in complex applications such as multi-label classification (where each input can belong to multiple classes simultaneously), the output layer 530 could have multiple neurons, each representing a different class, with each neuron outputting a probability of the input belonging to that specific class.

The activation function utilized in the output layer 530 can vary based on the desired output. For binary classification, a sigmoid function is commonly utilized to produce a probability between 0 and 1. For multi-class classifications, a softmax function can be applied to output a set of probabilities that sum to 1, indicating the most likely class. For regression problems, a linear activation function is often utilized to output a continuous range of values. The flexibility in designing the output layer 530 allows the neural network 500 to be applied to a wide variety of tasks, from simple binary decisions to complex multi-output predictions, making them a versatile tool in artificial intelligence and machine learning.

Although a specific embodiment for an example neural network 500 suitable for carrying out the various steps, processes, methods, and operations described herein is discussed with respect to FIG. 5, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 5, which is an illustrative example meant to make it easier to explain the basic concepts of neural networks and how they process information. The specific features and functions described herein are not intended to be limiting to this specific embodiment. The elements depicted in FIG. 5 may also be interchangeable with other elements of FIGS. 1-4 and FIGS. 6-12 as required to realize a particularly desired embodiment.

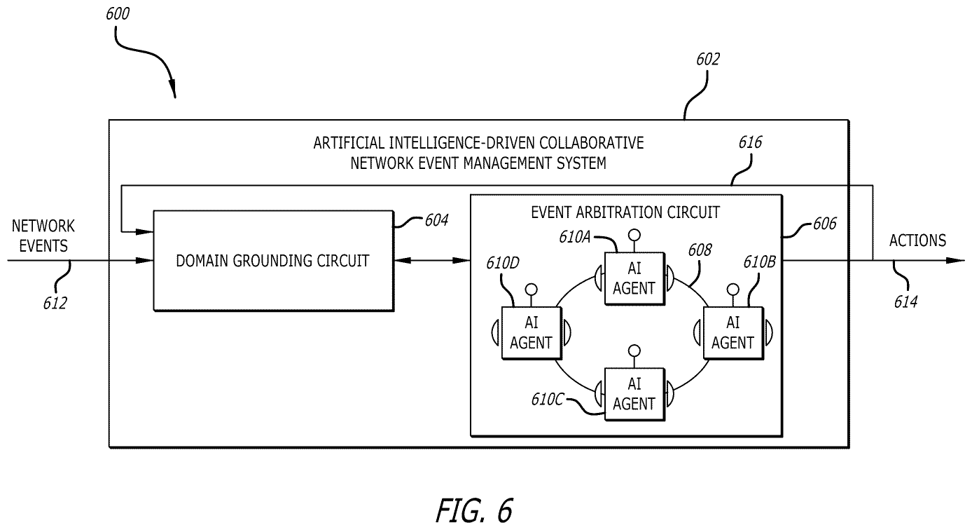

Referring to FIG. 6, a block diagram 600 illustrating an AI-driven Collaborative Network Event Management (CNEM) system 602 in accordance with various embodiments of the disclosure is shown. AI-driven CNEM may refer to a collaborative method for managing network events 612 by leveraging the combined efforts, designated roles, and resources of multiple AI agents 610A, 610B, 610C, and 610D (herein collectively referred to as “AI agents 610A-610D”) to detect, analyze, and respond to the network events 612 in a unified manner. The network events 612 may include, for example, syslog messages, alarms, Simple Network Management Protocol (SNMP) traps, or the like. The network events 612 may further include, for example, unplanned events or disruptions, also referred to as “incidents”, that negatively impact the normal operation of a network, or a device, a system, or a service in a network environment. Incidents may arise from critical network events or a combination of network events that may require immediate attention because they can lead to system failures, security breaches, or service disruptions. The network events 612 may be generated from different sources including, for example, network devices such as access points, routers, switches, firewalls, or the like, applications, or user actions. The network events 612 may reflect changes, for example, in network behavior, performance, security, or configuration. The network events 612 may be logged and may trigger alerts or automatic responses based on predefined conditions. The AI-driven CNEM system 602 may receive the network events 612 as input. In many embodiments, the network events 612 may include historic or live network events, which can be fed into the AI-driven CNEM system 602.

The AI-driven CNEM system 602 may include a domain grounding circuit 604. Domain grounding may refer to a process of providing context or a deep understanding of a specific domain, for example, a network domain, to allow the AI-driven CNEM system 602 to operate within that domain. Domain grounding may provide a clear and relevant foundation of knowledge about the domain in which the AI-driven CNEM system 602 may be intended to operate. In a number of embodiments, domain grounding may include aligning outputs or actions 614 of the AI-driven CNEM system 602 with real-world scenarios in the domain, ensuring that its decisions or predictions are practical and relevant. The domain grounding circuit 604 may provide access to domain-specific knowledge, either through structured data, for example, ontologies, knowledge graphs, or databases, or through unstructured data such as text or natural language documents, specialized reports, or the like. In an example, if any of the AI agents 610A-610D is trained for anomaly analysis, the domain grounding circuit 604 may provide domain grounding in areas such as packet structure, network traffic patterns, protocol knowledge, attack patterns, network configuration, network topology, communication between network devices, or the like.

In a variety of embodiments, the domain grounding circuit 604 may implement a mechanism for reducing AI hallucinations through event information including, for example, local context lookup, domain knowledge, local requirements and policies, event categories, or any combination thereof. In various embodiments, the domain grounding circuit 604 may include a local knowledge base configured to provide contextual information associated with the network environment. In more embodiments, the domain grounding circuit 604 may include a domain knowledge base configured to provide knowledge about the domain associated with the network environment. In additional embodiments, the event information may include, for example, a requirements document that enumerates specific needs and policies such as identification of critical services, network events, devices, types of network events that can trigger approved actions 614, or the like. In further embodiments, the event information may include, for example, event categories that provide a high-level classification of known event types and their meaning, event action logs that keep track of the actions 614 triggered by the AI agents 610A-610D, or the like. In still more embodiments, for self-learning, the AI agents 610A-610D may continually update the event action logs for new actions. The event information may provide an interpretation of domain-specific terminology, concepts, and relationships within the context of a task each AI agent (e.g., any of the AI agents 610A-610D) may perform.

The AI-driven CNEM system 602 may further include an event arbitration circuit 606 communicatively coupled to the domain grounding circuit 604. In still further embodiments, the domain grounding circuit 604 may receive the network events 612 and communicate the network events 612 along with domain grounding provided by the event information to the event arbitration circuit 606. The event arbitration circuit 606 may operate as the brain of the AI-driven CNEM system 602 and may implement collaborative AI reasoning of the AI agents 610A-610D to autonomously and iteratively make decisions, which drive the actions 614 associated with network management operations. Network management operations may refer to various tasks and processes involved in maintaining, monitoring, and optimizing the performance, security, and reliability of the network. These network management operations may be carried out for a smooth operation of the network infrastructure by a prompt addressal of any issues or potential problems identified in the network environment. The network management operations may include, for example, suppressing dependent network events, isolating network devices, shutting down or bringing up an interface, changing configurations, modifying a service construct, or the like. The event arbitration circuit 606 may evaluate the network events based on the event information received from the domain grounding circuit 604, determine the network management operations based on the evaluation, and trigger the actions 614 associated with the network management operations. In still additional embodiments, the event arbitration circuit 606 may implement a feedback mechanism 616 to further enhance the event information stored in the domain grounding circuit 604, thereby allowing the AI-driven CNEM system 602 to self-learn from prior actions.

The event arbitration circuit 606 may include multiple AI agents 610A-610D configured to operate in a collaborative event arbitration cycle 608. Each of the AI agents 610A-610D may be configured to perceive the network environment, reason a situation, and trigger actions 614 associated with the network management operations, autonomously. In some more embodiments, the AI agents 610A-610D may employ advanced NLP techniques of Large Language Models (LLMs) to comprehend and respond to user inputs step-by-step and determine when to call on external tools, for example, ticketing systems or the like. In yet various embodiments, the collaborative event arbitration cycle 608 may include autonomous arbitration corresponding to the network events 612 and/or the network management operations, by the AI agents 610A-610D. In the collaborative event arbitration cycle 608, the AI agents 610A-610D may analyze and process the network events 612 to determine their significance, prioritize them, and resolve any conflicts between different network events. The AI agents 610A-610D in the collaborative event arbitration cycle 608 may ensure that the most critical or relevant network events are handled appropriately, and any redundant or less significant network events are either ignored or filtered out to avoid unnecessary actions.

In yet more embodiments, on receiving the network events 612 from the domain grounding circuit 604, at least one of the AI agents 610A-610D, for example, the AI agent 610A, in the collaborative event arbitration cycle 608 may filter out network events that are routine, non-critical, or already handled by other processes. In this example, the AI agent 610A may utilize predefined rules, thresholds, or machine learning algorithms to determine which network events need further action. Another one of the AI agents 610A-610D, for example, the AI agent 610B, may then perform event correlation by grouping or relating the network events that are potentially connected, but not necessarily identical. For example, the AI agent 610B may correlate multiple action log entries indicating small failures in a network device into a single incident such as the network device going offline. Grouping related network events together may reduce noise in the event arbitration circuit 606, making it easier to identify a root cause of a problem. In complex network environments, correlated network events can help identify patterns, for example, a series of small failures leading to a larger issue such as a network attack or a hardware failure. Further, another one of the AI agents 610A-610D, for example, the AI agent 610C, may be configured to prioritize the network events based on their severity and impact on the network. For example, the AI agent 610C may assign a higher priority to critical network events such as security breaches, service outages, or network failures, over informational logs or minor alerts. This prioritization may allow network administrators or automated systems to address the most critical incidents first, reducing the risk of damage or service degradation. In still yet more embodiments, multiple network events that are either contradictory or need to be handled in a specific sequence may be generated as conflicts. Another one of the AI agents 610A-610D, for example, the AI agent 610D, may be configured to resolve these conflicts, ensuring that the network events that appear to be related but are caused by different issues do not cause unnecessary concern, and that actions 614 are triggered in the correct order. After the network events are filtered, correlated, and prioritized, the AI-driven CNEM system 602 may determine whether to trigger the actions 614 associated with the network management operations, for example, suppressing dependent events, isolating a network device, changing a configuration, transmitting an alert, triggering an automated remediation process, or escalating the issue for manual intervention. In many further embodiments, the actions 614 may include transmitting automated scripts as responses to some types of network events such as restarting a service in response to a detected failure, while more complex incidents may require manual intervention by network administrators. As the network events are processed, the AI-driven CNEM system 602 may execute the feedback mechanism 616 to learn from previous events and actions and adjust its filtering, prioritization, and correlation methods, thereby improving its efficiency and accuracy, reducing false positives and false negatives. Feedback from the actions 614 utilized to resolve incidents can feed into improving rules or machine learning algorithms utilized by the AI agents 610A-610D in the collaborative event arbitration cycle 608. The AI-driven CNEM system 602 may focus on coordination, communication, and information sharing across different AI agents 610A-610D in the collaborative event arbitration cycle 608 having different designated roles, ensuring faster identification and resolution of incidents, with a collective response to network issues, security threats, or performance degradation.

Although a specific embodiment for an AI-driven CNEM system 602 suitable for carrying out the various steps, processes, methods, and operations described herein is discussed with respect to FIG. 6, any of a variety of systems and/or processes may be utilized in accordance with embodiments of the disclosure. For example, in the collaborative event arbitration cycle 608, the AI-driven CNEM system 602 may schedule the operations of the AI agents 610A-610D based configurable criteria including, for example, task criticality for security monitoring, network conditions such as network traffic load, congestion points, or the like, resource availability, task complexity, dynamic context, environmental factors, or the like. The elements depicted in FIG. 6 may also be interchangeable with other elements of FIGS. 1-5 and FIGS. 7-12 as required to realize a particularly desired embodiment.

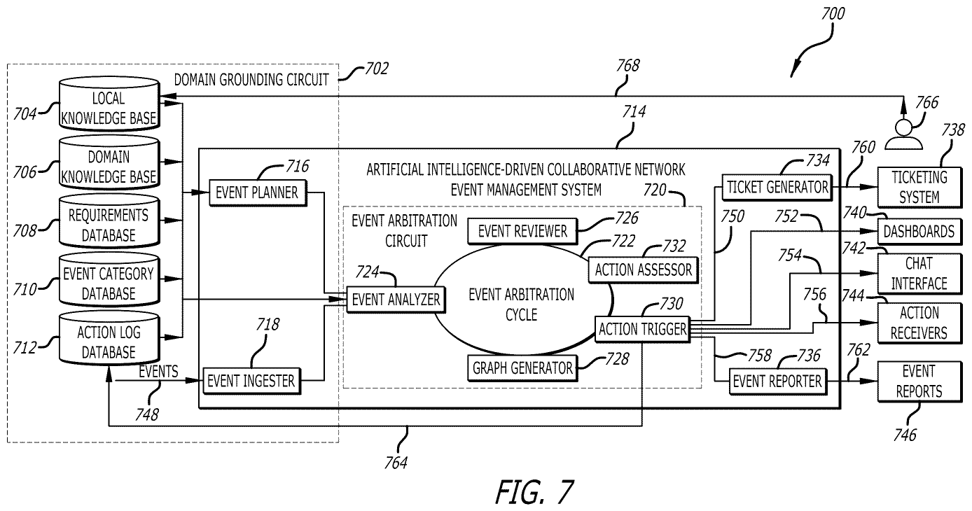

Referring to FIG. 7, a block diagram 700 illustrating the AI-driven CNEM system 714 executing an event arbitration cycle 722 in accordance with various embodiments of the disclosure is shown. The event arbitration cycle 722 may refer to an autonomous and collaborative cycle where multiple autonomous AI agents work together in an ongoing, self-regulating process to analyze network events 748, resolve conflicts, make decisions, and trigger actions 750-758, with minimal or no user intervention. Consider an example where the AI-driven CNEM system 714 may be utilized for managing multiple network events 748 in a network environment. The AI-driven CNEM system 714 may include a domain grounding circuit 702 and multiple AI agents. In many embodiments, the domain grounding circuit 702 may include one or more databases for performing domain grounding and providing context or a deep understanding of a specific domain, for example, a network domain, to the AI agents to operate within that domain. In an example implementation illustrated in FIG. 7, the domain grounding circuit 702 may include a local knowledge base 704, a domain knowledge base 706, a requirements database 708, an event category database 710, and an action log database 712, herein collectively referred to as “the databases 704-712”. The databases 704-712 that constitute the domain grounding circuit 702 ground the AI-driven CNEM system 714 with event information associated with the network environment.

In a number of embodiments, the local knowledge base 704 may store contextual information associated with the network environment. In a variety of embodiments, the local knowledge base 704 may be created by utilizing user-provided contextual information and can be updated by continual feedback 768. The contextual information stored in the local knowledge base 704 may include any information or variables that provide an additional context relevant for the local network environment in which the AI agents function and that assist the AI agents in understanding specific conditions, constraints, and operational characteristics of the local network environment. For example, the contextual information may include a network topology or a layout of network devices such as access points, routers, switches, firewalls, servers, or the like and their connections, network segmentation, network traffic patterns, latency and performance metrics, or the like. In further examples, the contextual information may include characteristics of network links that may influence routing, traffic shaping, resource allocation, or the like, security context, device information, device configuration, resource availability, network faults, session information, or the like. The contextual information may provide the AI agents with an added context and relevance to the local network environment with feedback, thereby assisting the AI agents in making better-informed decisions tailored to the aspects of their network environment.

In various embodiments, the local knowledge base 704 is configured as an embedding vector database to store and manage high-dimensional vector representations, referred to as embeddings, of data points. In more embodiments, these embeddings may be generated using ML models, where complex data such as text, images, audio, videos, or the like may be transformed into a numerical vector representation. In an example, information about the network topology can be encoded into vector representations that capture relationships and structure between the network devices, and stored in the local knowledge base 704. This encoding may be performed through graph-based embeddings, where each network device or node in the network may be embedded as a vector, and the relationships or edges between the network devices may also be represented as vectors. In a further example, network event data can be represented as time-series data or aggregated patterns (e.g., daily usage, application-specific traffic), transformed into embedding vectors that capture network traffic volume, usage peaks, and types of data transmitted, and stored in the local knowledge base 704. In a further example, latency, jitter, or throughput statistics can be transformed into embedding vectors that capture performance characteristics over time and stored in the local knowledge base 704. In a further example, intrusion attempts, malware activity, or security vulnerabilities may be encoded into embedding vectors that represent the severity, type, and frequency of the network events 748 and stored in the local knowledge base 704. For example, security data such as failed login attempts, suspicious traffic, or attack vectors can be mapped to embeddings that represent specific attack types.

In additional embodiments, the domain knowledge base 706 may store knowledge about a domain associated with the network environment. The knowledge about the domain may herein be referred to as “domain knowledge.” The domain may include a network domain associated, for example, with network infrastructure, connectivity, communication, security, storage, applications, or the like, in the network environment. The domain associated with the network infrastructure may include, for example, physical and logical components such as routers, switches, firewalls, access points, servers, and other devices that interconnect to form the network. The domain associated with connectivity and communication may focus on how data flows across the network and may include, for example, protocols, bandwidth management, and routing. The domain associated with security may encompass aspects, for example, firewalls, intrusion detection systems, virtual private networks, encryption, or the like, related to the protection of the network from unauthorized access, attacks, vulnerabilities, or the like. The domain associated with storage may focus on how data is stored, accessed, and managed across the network and may include, for example, centralized data storage, distributed file systems, cloud storage, or the like. The domain associated with applications may focus on client-side and server-side applications and services that run on the network, ranging, for example, from email to web servers. In further embodiments, the domain knowledge may include a natural language document that provides basic knowledge about a domain of interest with introductory descriptions about the domain. The domain knowledge may assist the AI agents to align with the scope of the domain and add the scope of the domain to their knowledge.

In still more embodiments, the requirements database 708 may store one or more requirements associated with at least one policy corresponding to the network environment. In still further embodiments, a user may enumerate specific needs and policies, for example, identification of critical services, network events, network devices, types of network events that can trigger approved actions with registered action receivers 744, or the like, as requirements in one or more requirements documents for storage in the requirements database 708. In still additional embodiments, the policies may dictate which groups of users, through a user interface such as a chat interface 742, may be allowed to perform certain actions. The requirements database 708 may store the requirements document(s) for grounding the AI agents. The requirements document(s) may guide the AI agents to perform faster decision-making and control the actions that the AI agents can take. In some more embodiments, as the policies in the requirements document(s) may be configurable, initial deployment may allow the AI agents to make recommendations without executions. In yet various embodiments, the policies in the requirements document(s) may selectively allow autonomous executions of actions by one or more of the AI agents. In yet more embodiments, the policies such as network traffic prioritization, for example, Voice over Internet Protocol (VoIP) over file transfers, can be encoded as embedding vectors that represent Quality-of-Service (QoS) rules and stored in the requirements database 708. These embedding vectors may assist the AI agents in conforming to business rules during operation. In still yet more embodiments, the requirements document(s) may further include compliance information, for example, General Data Protection Regulation (GDPR) rules, data handling protocols, etc., captured by embeddings and stored in the requirements database 708. These embeddings may provide an additional context to adhere network management operations to legal and regulatory requirements.

In many further embodiments, the event category database 710 may store one or more event categories indicating known event types and meanings of the known event types. The event categories may provide a high-level classification of known event types and their meanings to the AI agents. The event categories may assist the AI agents in analyzing the network events 748 with guidance on priority. In many additional embodiments, the action log database 712 may store one or more event action logs associated with the network environment. The event action log(s) may keep track of the actions 750-758 triggered by the AI agents. For self-learning, the AI agents may continually update new actions in the event action log(s) stored in the action log database 712. The event action log(s) may store the actions 750-758 that are either recommended or executed for a network event within its state machine, thereby providing additional context to the AI agents when a similar network event is received. The event action log(s) may also store frequency of occurrence of each network event for utilization in cases including, for example, a denial-of-service process, a runaway process, or the like.

The information stored in the databases 704-712 may constitute the event information utilized for grounding the AI agents. In still yet further embodiments, each of the AI agents may execute at least one ML model, for example, an LLM, a Large Action Model (LAM), or the like, for evaluating the network events 748 based on the event information. In still yet additional embodiments, the AI agents may be configured with designated roles including, for example, event planning, event ingesting, event analysis, event review, graph generation, action assessment, action trigger, ticket generation, event reporting, or the like. In the example implementation illustrated in FIG. 7, the AI-driven CNEM system 714 may include nine (9) AI agents, namely, an event planner 716, an event ingester 718, an event analyzer 724, an event reviewer 726, a graph generator 728, an action trigger 730, an action assessor 732, a ticket generator 734, and an event reporter 736. The AI-driven CNEM system 714 may further include an event arbitration circuit 720 constituted by a preconfigured number of AI agents. For example, about five (5) AI agents, namely, the event analyzer 724, the event reviewer 726, the graph generator 728, the action assessor 732, and the action trigger 730 may constitute the event arbitration circuit 720 as illustrated in FIG. 7. These five AI agents, for example, the event analyzer 724, the event reviewer 726, the graph generator 728, the action assessor 732, and the action trigger 730, of the event arbitration circuit 720 may be configured to operate in the event arbitration cycle 722.

The network events 748 (denoted as “events 748”) may be generated by different components, for example, network devices such as access points, routers, switches, firewalls, servers, or the like, in the network environment. The network events 748 may have varying levels of severity or criticality. The network events 748 may include, for example, syslog messages, alarms, SNMP traps, or the like. The event ingester 718 in the AI-driven CNEM system 714 may receive the network events 748 from the network environment. The event ingester 718 may execute at least one ML model, for example, an LLM, for processing the network events 748 through operations such as cleaning, deduplication, enrichment, event classification, and relationship identification. In several embodiments, for cleaning the received network events 748, the event ingester 718 may scan the network events 748 for incomplete, corrupted, or erroneous data, and eliminate or correct the corresponding network events. The event ingester 718 may filter out invalid entries, handle missing data, and standardize the format of the network events 748 to remove noise and irrelevant data, ensuring only valid actionable network events are left for further processing. For example, if a network event lacks critical information such as a source address or a timestamp, the event ingester 718 may discard that network event or flag that network event for further investigation. In several more embodiments, the event ingester 718 may remove duplicate network events, thereby precluding redundant analysis and alert fatigue. For deduplication, the event ingester 718 may compare the received network events 748 with previously recorded network events to identify duplicates based on criteria including, for example, similar timestamps, source addresses, or event types. If the same network event is logged multiple times within a short time span, the event ingester 718 may retain only one instance of the network event and discard the other network events. In numerous embodiments, the event ingester 718 may enrich the received network events 748 with additional context, making them more useful for analysis and decision-making. In numerous additional embodiments, the event ingester 718 may utilize the event information from the databases 704-712 to enrich the received network events 748. For example, the event ingester 718 may enrich a raw network event indicating an unusual connection attempt with geographic location data, threat intelligence information such as whether the IP is known to be associated with malicious activity, user details, or the like.

In further additional embodiments, the event ingester 718 may classify the network events 748 into broad categories or groups, for example, security events, traffic events such as traffic anomalies, configuration events, operational events, compliance events, or performance events, that align with the primary areas of interest or concern in the network environment. The event ingester 718 may execute at least one ML model, for example, an LLM, to classify the network events 748 based on their attributes or features such as event type, severity, source, etc., or based on preconfigured rules that map specific types of network behavior to the categories. In an example, the event ingester 718 may classify a Distributed Denial-of-Service (DDoS) attack event under “security incidents,” and a server Central Processing Unit (CPU) overload under “system health” or “performance events.” In many embodiments, the event ingester 718 may determine relationships between the received network events 748 based on attributes or features such as time, source, impact, or the like. The event ingester 718 may establish connections between the network events 748 to reveal broader patterns or trends, thereby uncovering more complex issues or attacks. For example, if a series of failed login attempts are followed by a successful login from an unusual location, the event ingester 718 may correlate these network events 748 to detect a potential account compromise.

The event ingester 718 may communicate the processed network events to the event analyzer 724. The event analyzer 724 may be in operable communication with the event planner 716. In a number of embodiments, the event information from the databases 704-712 may be fed into the event planner 716 and the event analyzer 724. In addition to receiving the event information, the event planner 716 may receive and synthesize user input, and execute at least one ML model, for example, an LLM, for planning operations to be performed by the AI agents (e.g., the event analyzer 724, the event reviewer 726, the graph generator 728, the action assessor 732, and the action trigger 730) in the event arbitration circuit 720, prioritizing the processed network events, and generating decision paths for the network events. In a variety of embodiments, the event planner 716 may prioritize the network events based on potential impact or damage the network events can cause to the network environment. For example, the event planner 716 may assign the highest priority to the network events that may cause significant harm or disruption, such as security breaches, DDoS attacks, system failures, or the like. In a further example, the event planner 716 may assign a medium priority to the network events that are concerning but not immediately critical, such as performance degradation, minor configuration errors, or the like, and a low priority to the network events that have minimal or no immediate impact, such as low-level system warnings, informational logs, or the like. In various embodiments, after assessing the context and impact of the network events, the event planner 716 may generate decision paths. For example, for high-severity events or security breaches such as DDoS attacks, unauthorized logins, or the like, the event planner 716 may generate a decision path including immediate countermeasures such as blocking the malicious IP, isolating the affected network device, or activating security protocols. The event planner 716 may communicate the outputs of the ML model(s) to the event analyzer 724 for further analyses.

In more embodiments, the event analyzer 724 may be configured to perform event correlation, root cause analysis, anomaly analysis, local knowledge retrieval for human knowledge including, for example, local Retrieval-Augmented Generation (RAG), or the like. The event analyzer 724 may utilize the event information from the databases 704-712 to enhance the knowledge of the ML model(s) executed by the event analyzer 724. In additional embodiments, the event analyzer 724 may also execute an event lifecycle and check on the status of the current network event in previous runs. The event analyzer 724 may perform event correlation by identifying predefined patterns or correlations between the network events based on event types, source/destination pairs, time windows, or specific behaviors indicative of potential security incidents. For example, the event analyzer 724 may correlate an intrusion detection system alert about suspicious network traffic on Port 80, followed by a log indicating a successful web shell connection to detect a possible web application attack. The event analyzer 724 may utilize the event information from the databases 704-712 for increasing the accuracy of the event correlations.

In further embodiments, for performing the root cause analysis, the event analyzer 724 may identify the network event or problem such as an unexpected network slowdown, a security breach, an unplanned downtime, a service disruption, or the like. The event analyzer 724 may utilize the event information from the databases 704-712 to understand the context and impact of the identified network event, identify patterns such as recurring errors, spikes in network load, specific network devices involved, or consistent timeframes when an issue arises, build a timeline of network events leading up to the issue, investigate specific areas of the network that may be contributing to the issue, and generate a hypotheses about the possible causes of the network events.

In still more embodiments, the event analyzer 724 may perform the anomaly analysis to identify unusual patterns or behaviors that deviate from normal behavior, which may indicate potential issues such as security breaches, performance degradation, or misconfigurations in the network. In still further embodiments, for performing the anomaly analysis, the event analyzer 724 may analyze the event information to establish baseline network performance and network traffic patterns. The event analyzer 724 may execute one or more ML models, for example, LLMs, to process the event information and identify typical patterns of network usage such as peak hours for traffic, expected latency, normal bandwidth usage, or the like. The event analyzer 724 may continuously analyze incoming network events and compare the network events against the established baseline to identify any network event or pattern that deviates from the normal behavior. A deviation may include, for example, a sharp spike in bandwidth usage, an unexpected increase in error rates, or any other unusual pattern that suggests a potential problem.

In still additional embodiments, for performing the local RAG, the event analyzer 724 may execute one or more ML models, for example, LLMs, to transmit a query to the databases 704-712 based on the user's prompt or an observed network event. The event analyzer 724 can search for relevant historical incidents, patterns, or configurations that are similar to the current issue, and narrow down the retrieval to data that may most likely help diagnose the current issue. The event analyzer 724 may retrieve critical pieces of data, logs, or configurations that appear to be directly related to a detected anomaly or issue. In the case of live events, the event analyzer 724 may retrieve the most recent data points, for example, the last 24 hours of network activity logs or the real-time performance data of a particular router or segment of the network. The event analyzer 724 may then augment its generation by combining the retrieved local data with its own knowledge. The event analyzer 724 may process and utilize the retrieved local data as context to generate a relevant response. The event analyzer 724 may communicate the analytical results of the ML model(s) to the event reviewer 726 for review and feedback.

In some more embodiments, the event reviewer 726 may execute at least one ML model, for example, an LLM, for reviewing the analytical results received from the event analyzer 724 and generating feedback corresponding to the network events. The event reviewer 726 may receive a preliminary analysis from the event analyzer 724, including the event information from the databases 704-712 and a proposed diagnosis. The event reviewer 726 may verify conclusions drawn by the event analyzer 724, for example, by checking for logical consistency in the root cause analysis and the anomaly analysis, verifying the relevance of the network event data utilized in the analyses such as verifying that the CPU load and traffic spike data are from the right network devices and timeframes, cross-referencing suggested remediation steps with known best practices or historical solutions for similar events, or the like. With the feedback, the event reviewer 726 may provide more contextual understanding or higher-level insights to the event analyzer 724 to ensure the analytical results are relevant in the larger network context. For example, the event reviewer 726 may suggest that high CPU usage may be due to a known pattern of behavior during peak traffic periods, rather than an issue that requires immediate remediation. The event reviewer 726 may refine or adjust the analysis based on deeper knowledge or external factors that the event analyzer 724 may not have fully considered, for example, by including recent changes to network topology, upcoming maintenance schedules, or the like. The event reviewer 726 may communicate the feedback to the event analyzer 724 allowing for a collaborative analysis of the network events 748.

In yet various embodiments, the graph generator 728 may execute at least one ML model, for example, an LLM, for mapping out relationships between various components in the network environment, the network events 748, and anomalies, and generating a dependency graph also referred to as a “relationship graph”. The graph generator 728 may utilize the event information received from the databases 704-712 to perform correlations of different types, for example, a temporal correlation, a device and service correlation, a network traffic path analysis, or the like, and generate the dependency graph. In an example, the graph generator 728 may correlate a network congestion event to determine the network devices experiencing high traffic and the network devices that are downstream and affected by congestion. After correlating the network events, the graph generator 728 may generate a dependency graph that visually represents the relationships and dependencies between the network devices, services, and network traffic flows. Each node in the dependency graph may represent a network device, a service, or an application. The edges, that is, the connections between the nodes, may represent the dependencies or relationships between the network devices and services. These dependencies or relationships may include, for example, physical connections such as a router connected to a switch, or logical dependencies such as an application relying on a database server. The graph generator 728 may tie the network events to specific nodes or edges. For example, if a router experiences high CPU usage, the graph generator 728 may tie the node representing that router to an associated event such as high CPU usage. The edges in the dependency graph may be weighted to represent the strength or severity of the dependency. For example, a high-priority connection between a core router and a critical server may have a heavier weight than a low priority connection between two switches. In yet more embodiments, the dependency graph may be dynamic, that is, the graph generator 728 may update the dependency graph as new network events occur or as the status of network components changes in real time. The graph generator 728 may communicate the dependency graph to the event reviewer 726 in the event arbitration cycle 722. In still yet more embodiments, the event reviewer 726 may perform a graph walk, that is, a process of traversing or exploring the nodes and edges within the dependency graph to gain insights, analyze the network events, or track how issues propagate across the network.

In many further embodiments, the action trigger 730 may execute at least one ML model, for example, an LAM, for determining network management operations configured to address critical network events based on the collaborative evaluation performed by the event analyzer 724, the event reviewer 726, and the graph generator 728. The network management operations may include, for example, suppressing dependent network events, isolating a network device, directly changing the network device based on a policy, shutting down or bringing up an interface, changing configurations, modifying a service construct, or the like. The action trigger 730 may trigger actions 750-758 associated with the determined network management operations. The actions 750-758 may include direct changes to network devices if a policy allows, generating alerts, opening a ticket via the ticket generator 734, generating event reports 746 via the event reporter 736, or the like. In many additional embodiments, the action trigger 730 may perform conditional triggering of the actions 756 to registered action receivers 744. For example, the actions 756 may correspond to recommendations associated with the network management operations or executions of the network management operations. The action receivers 744 may refer to systems or components that receive and process the actions 756 triggered by the action trigger 730. The action receivers 744 may respond to the actions 756 triggered by another system, for example, the action trigger 730, a network administrator, or an automated system. In still yet further embodiments, any of the actions 750-758, for example, the actions 756, may be revertive, requiring the action trigger 730 to confirm the actions 756. In still yet additional embodiments, the revertive actions may force a confirmation of the actions from the action trigger 730 within a configurable expiration period. If the action trigger 730 confirms the revertive actions within the configurable expiration period, the network management operation that was executed may be retained. If the action trigger 730 does not confirm the revertive actions within the configurable expiration period, the network management operation that was executed may be reverted or aborted.

The action trigger 730 may communicate the actions 750-758 to the action assessor 732 in the event arbitration cycle 722 for assessment of the actions 750-758. The action assessor 732 may review the actions 750-758, perform a resource assessment, and conduct action dry runs to ensure the actions 750-758 proposed by the action trigger 730 are reasonable and can be executed with appropriate network resources. An action dry run may involve a workflow showing execution of all operations of an actual run without execution of code that performs changes or modifications in the network. The action dry runs may include simulations or previews of an action or a set of actions without performing the changes or the modifications in the network. The action assessor 732 may perform the action dry runs to ensure that the actions 750-758 triggered by the action trigger 730 have the desired effect and to identify any potential issues or unintended consequences before executing the actions 750-758. In several embodiments, the action assessor 732 may execute at least one ML model, for example, an LAM, for evaluating, prioritizing, and assessing the impact of the actions 750-758 associated with the network management operations. The LAM may include a repository of actions associated with various network management operations such as traffic rerouting, device reboots, configuration adjustments, load balancing, scaling up resources, alerting or escalating issues, or the like, and their potential impacts. The LAM may determine how these actions 750-758 interact with the network infrastructure, the dependencies between the network devices and services, and how these changes may affect performance, security, and reliability. The LAM may define categories of actions such as reactive versus proactive, preventive versus corrective, or the like, and conditions under which each action in the LAM is executed.

When a network event, for example, a performance anomaly or a failure, occurs, the action assessor 732 may evaluate potential actions by considering the current state of the network and the impact of various actions within the context of the situation. Once the assessment is complete, the action assessor 732 may determine which action or combination of actions should be triggered and communicate the result to the action trigger 730. In an automated mode, the action trigger 730 may initiate an action (e.g., any of the actions 750-758) directly without user intervention. For example, if a router is down and the action assessor 732 assesses that rebooting the router may resolve the issue with minimal risk, the action trigger 730 can initiate a reboot automatically. In a further example, if a network bottleneck is detected, the action trigger 730 may reroute network traffic or adjust load balancing settings. In a further example, if a hardware failure is detected, the action trigger 730 may escalate the issue to a network engineer while also triggering a temporary failover to backup systems. If user intervention is needed, the action trigger 730 may escalate a decision to network administrators, providing them with detailed insights into recommended actions and their potential outcomes.

In several more embodiments, the action trigger 730 may trigger an action 750 to the ticket generator 734 that also operates as an AI agent. The ticket generator 734 may perform tool calls 760 to a ticketing system 738 to open a context-filled ticket for executing a network management operation. A tool call 760 may include, for example, invoking network diagnostic tools, initiating network reconfiguration, or escalating an issue to the ticketing system 738 for troubleshooting. The ticket generator 734 may execute at least one ML model, for example, an LLM, for automating the creation of tickets, for example, for issue tracking, incident management, or the like, and triggering relevant tool calls 760 to remediate or escalate network issues based on specific network events or incidents. The LLM may automatically create content for the ticket with relevant details to assist network administrators or support personnel in resolving the issue. The LLM may understand the context from previous network incidents and relevant ticket templates, ensuring the created ticket is both detailed and concise. As the tool calls 760 are executed and the tickets are created, a user 766, for example, a network administrator, may transmit the outcomes of the actions 750-758 to the domain grounding circuit 702. For example, the user 766 may provide feedback 768 associated with the actions 750-758 via a user interface such as a chat interface 742 for updating the local knowledge base 704 based on the feedback 768.

In numerous embodiments, the action trigger 730 may trigger an action 752 to generate dashboards 740 to allow customization and interactions with the AI-driven CNEM system 714. In numerous additional embodiments, the action trigger 730 may trigger an action 754 to render a user interface for example, the chat interface 742, that facilitates one or more interactions between a user and the AI agents. The chat interface 742 may allow human-AI interactions for direct Questions (Q) and Answers (A). The action trigger 730 may trigger further actions based on the interactions. In further additional embodiments, on identification of certain network events, the action trigger 730 may provide automated action triggers to the registered action receivers 744. In many embodiments, the action trigger 730 may trigger an action 758 to the event reporter 736 that also operates as an AI agent. The event reporter 736 may generate event reports 746 to allow customization and interactions with the AI-driven CNEM system 714. In a number of embodiments, the event reporter 736 may execute at least one ML model, for example, an LLM, for generating the event reports 746. In a variety of embodiments, the event reporter 736 may transmit the event reports 746 to user devices via a network link 762. The event reporter 736 may allow personalized reporting for each user. In various embodiments, besides the automated action triggers, the actions 750-758 can be triggered manually through the chat interface 742. The AI-driven CNEM system 714 allows customization of all user-facing outputs. For example, a network executive may receive higher-level personalized event reports 746 and chat responses, without exposing many technical details. In more embodiments, the action trigger 730 may generate and transmit event action logs 764 associated with the actions 750-758 to the domain grounding circuit 702 for updating the action log database 712. The event action logs 764 provide a detailed record of all actions taken in response to specific network events. The event action logs 764 may include, for example, event identifiers, event description, a description of the triggered actions 750-758, the entity that execute the network management operations associated with the actions 750-758, results of the actions 750-758, or the like.

The AI agents (e.g., the event analyzer 724, the event reviewer 726, the graph generator 728, the action assessor 732, and the action trigger 730) on the event arbitration cycle 722 work collaboratively and iteratively to analyze the network events, perform classifications, evaluate the classifications, generate relationship graphs, walk the relationship graphs to identify dependencies and correlations, prioritize the network events, and trigger the actions 750-758. The arbitrations in the event arbitration cycle 722 may occur, for example, during the review of the analyzed network events by the event reviewer 726, during the generation of the actions 750-758 by the action trigger 730, and during assessment of the actions 750-758 by the action assessor 732. In an example, during the review of the analyzed network events where the event reviewer 726 may review the analysis performed by the event analyzer 724, arbitration may be performed to prioritize which network events are the most critical. In a further example, while generating the actions 750-758, the action trigger 730 may arbitrate which actions should be taken to resolve the issue based on impact, resources, and feasibility. In a further example, during the assessment of the actions 750-758, the action assessor 732 may arbitrate the effectiveness and risk of each action and select the most appropriate action for recommendation or immediate execution.

Although a specific embodiment for an AI-driven CNEM system 714 executing an event arbitration cycle 722 suitable for carrying out the various steps, processes, methods, and operations described herein is discussed with respect to FIG. 7, any of a variety of systems and/or processes may be utilized in accordance with embodiments of the disclosure. For example, in additional embodiments, ML models such as Recurrent Neural Networks (RNNs) or transformers can be utilized to convert traffic time-series data into embeddings that capture underlying patterns in network events for storage in the local knowledge base 704 and for utilization as the event information. In further embodiments, a statistical approach may be utilized to aggregate network event data over time and represent the network event data as a vector. The elements depicted in FIG. 7 may also be interchangeable with other elements of FIGS. 1-6 and FIGS. 8-12 as required to realize a particularly desired embodiment.

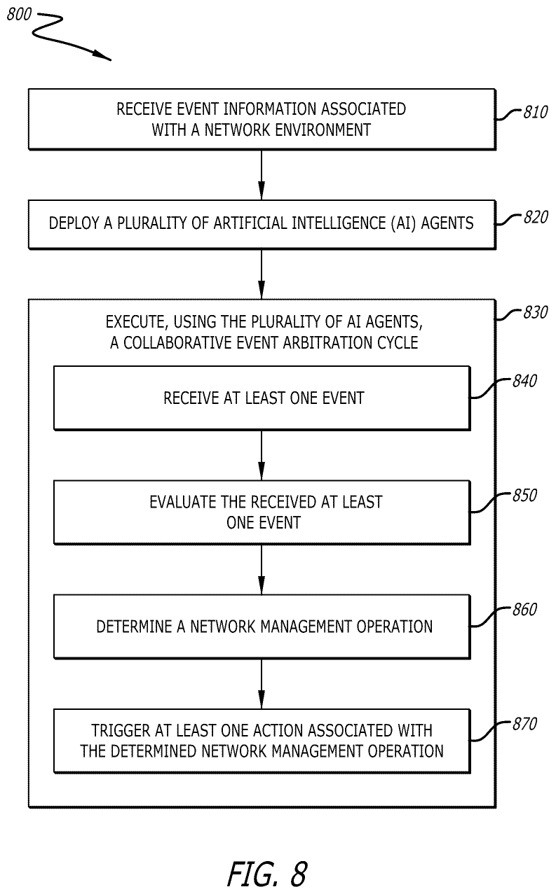

Referring to FIG. 8, a flowchart depicting a process 800 for collaboratively managing events associated with a network environment in accordance with various embodiments of the disclosure is shown. In many embodiments, the process 800 may receive event information associated with a network environment (block 810). The event information may relate to events including, for example, syslog messages, alarms, SNMP traps, incidents, or the like, also referred to as “network events.” In a number of embodiments, the event information may be received from a local knowledge base configured to provide contextual information associated with the network environment. In a variety of embodiments, the local knowledge base is configured as an embedding vector database. In various embodiments, the process 800 may create and update the local knowledge base by utilizing user data and feedback received from one or more users. In more embodiments, the event information may be received from a domain knowledge base configured to provide knowledge about a domain associated with the network environment. In additional embodiments, the event information may include one or more requirements associated with at least one policy corresponding to the network environment. The requirement(s) may enumerate specific needs and policies such as identification of critical services, network events, network devices, types of network events that can trigger approved actions, or the like. In further embodiments, the event information may include at least one event category indicating a known event type and a meaning of the known event type. In still more embodiments, the event information may include at least one event action log associated with the network environment. The event action log(s) may track the actions generated by the AI-driven CNEM system discussed herein for executing network management operations.

In still further embodiments, the process 800 may receive the event information from various sources including, for example, network devices such as access points, routers, switches, firewalls, or the like, applications, user actions, feedback, or any combination thereof, in the network environment. In still additional embodiments, the process 800 may receive feedback associated with at least one action via a user interface, for example, a chat interface, rendered by the AI-driven CNEM system, and update the event information based on the received feedback. In some more embodiments, the process 800 may utilize the event information to implement domain grounding of multiple AI agents that operate collaboratively in the AI-driven CNEM system.

In yet various embodiments, the process 800 may deploy a plurality of AI agents (block 820). In yet more embodiments, the AI agents may correspond to generative AI agents. The AI agents may be configured to operate in a collaborative cycle. Each of the AI agents has a designated role in the collaborative cycle. In still yet more embodiments, for each of the AI agents, the process 800 may select the designated role from multiple roles including, for example, event planner, event analyzer, event reviewer, graph generator, action assessor, action trigger, or the like. The AI agents may work autonomously and collaboratively in an ongoing, self-regulating process to resolve conflicts, make decisions, and ensure consistency across the AI-driven CNEM system without requiring constant user intervention.

In many further embodiments, the process 800 may execute, using the plurality of AI agents, a collaborative event arbitration cycle (block 830). In many additional embodiments, the collaborative cycle may be a collaborative event arbitration cycle. The collaborative event arbitration cycle may include, for example, an autonomous arbitration corresponding to the network event or the network management operations, by the AI agents. The arbitration may include a process of resolving conflicts or differences in decision-making, for example, when there is a disagreement between the AI agents about how to handle a particular network event or execute an action associated with a network management operation. In the collaborative event arbitration cycle, each AI agent can contribute its input, evaluate the network events from its own perspective, and interact with other AI agents to establish a resolution to conflicts. The collaborative event arbitration cycle may iterate through a series of steps to identify and resolve these conflicts, ensuring that the AI agents eventually reach a consensus or an appropriate resolution. In the collaborative event arbitration cycle, the arbitration process is ongoing with continuous evaluation, exchange of the event information and outcomes, refinement of responses, and resolution of conflicts as they arise.

In still yet further embodiments, as part of the collaborative event arbitration cycle, the process 800 may receive at least one event (block 840). The event(s) may relate to a network event including, for example, a syslog message, an alarm, an SNMP trap, an incident, or the like. The process 800 may receive the event(s) from one or more sources including, for example, network devices such as access points, routers, switches, firewalls, or the like, applications, or user actions, in the network environment. In still yet additional embodiments, the process 800 may utilize one of the deployed AI agents having a designated role, for example, as an event ingester, to receive the event(s). In several embodiments, the process 800 may trigger the AI agent to execute at least one ML model, for example, an LLM, for processing the received event(s) through operations such as cleaning, deduplication, enrichment, event classification, and relationship identification.

In several more embodiments, as part of the collaborative event arbitration cycle, the process 800 may evaluate the received at least one event (block 850). The process 800 may evaluate the received event(s) based on the received event information. In the collaborative event arbitration cycle, each of the AI agents may be configured to execute at least one ML model for the evaluation of the received event(s). The evaluation of the received event(s) may include, for example, performing at least one classification of the received event(s), evaluating the classification(s), generating a relationship graph based on the evaluation, identifying one or more correlations between the received event(s) and another event associated with the network environment based on the generated relationship graph, and assigning a priority to each of the received event(s) and the other event based on the identified correlation(s). The process 800 may continue to run the collaborative event arbitration cycle as new events or conflicts arise, enabling the AI-driven CNEM system to dynamically adjust and maintain consistency across all the AI agents.

In numerous embodiments, as part of the collaborative event arbitration cycle, the process 800 may determine a network management operation (block 860). The process 800 may determine the network management operation based on the evaluation. The network management operation may include, for example, suppressing dependent network events, isolating network devices, shutting down or bringing up an interface, changing configurations, modifying a service construct, or the like. In an example, when the process 800 may receive an event related to a failure of a critical router or switch, which may cause multiple downstream services or network links to experience downtime, thereby generating multiple alarms or alerts for each affected downstream service. Rather than flooding action receivers with multiple alarms for each dependent event, the process 800 may decide to perform a network management operation including suppressing some of the alarms, allowing focus on the root cause, that is, the failure of the critical router or switch.

In numerous additional embodiments, as part of the collaborative event arbitration cycle, the process 800 may trigger at least one action associated with the determined network management operation (block 870). In further additional embodiments, the action(s) may correspond to a recommendation or an execution. In an example, for a network management operation such as isolating network devices, the action recommended or executed may include disconnecting a network device by either disabling its physical port, blocking its IP address, or performing network segmentation by placing the network device in a quarantine Virtual Local Area Network (VLAN). In a further example, for a network management operation such as shutting down or bringing up an interface, the action recommended or executed may include disabling the interface or bringing the interface back up automatically once the root cause is fixed, or rerouting network traffic through other interfaces, if necessary. In a further example, for a network management operation such as changing configurations or configuring network devices including routers, switches, or the like, and their settings, the action recommended or executed may include configuring device parameters, enabling/disabling interfaces, setting up routing protocols, applying security policies, or the like. In a further example, for a network management operation such as modifying a service construct, the action recommended or executed may include adding, removing, or reconfiguring the service construct based on network traffic patterns, application requirements, or user demand. For example, if traffic load on a specific VLAN is too high, the process 800 may move certain users to a different VLAN to balance the load.

In many embodiments, the process 800 may trigger an action for generating event reports to one of the AI agents operating as an event reporter. The event reporter may generate event reports to allow customization and interactions with the AI-driven CNEM system. The event reports may include detailed information about network events, their causes, associated network management operations, and corresponding actions. For example, an event report may include an event identifier, a timestamp, an event type, a source, a description, an event category, affected network devices or services, context, root cause, impact, actions taken, event correlation, resolution status, event source, acknowledgements, notifications, or the like. The event reporter may allow personalized reporting for each user. In a number of embodiments, the process 800 may trigger an action for opening a ticket to one of the AI agents operating as a ticket generator. The ticket generator may perform tool calls to a ticketing system to open a context-filled ticket for executing a network management operation. In a variety of embodiments, the process 800 may render a user interface, for example, a chat interface, that facilitates one or more interactions between a user and the AI agents. The process 800 may trigger the action(s) based on the interaction(s). In various embodiments, the process 800 may update the event action log(s) based on the triggered action(s).

Consider an example where multiple AI agents of the AI-driven CNEM system operate in a collaborative event arbitration cycle. The AI-driven CNEM system may receive event information associated with the network environment and utilize the event information to implement domain grounding of the AI agents. The AI-driven CNEM system may receive several network events, for example: (a) a network device reporting a high CPU usage; (b) a security alert being triggered due to an unusual number of failed login attempts on one network device; and (c) a routine ping test showing a slight delay in response from a network device. The AI-driven CNEM system may execute the collaborative event arbitration cycle on the received network events using the AI agents. The AI agents evaluate the network events based on the received event information and determine a network management operation based on the evaluation. By way of a non-limiting example, the AI agents may include an event ingester, an event analyzer, an event reviewer, an action trigger, and an action assessor. The event ingester may filter the received network events and ignore routine network events such as the ping delay or deem those network events as less significant compared to the security alert. The event analyzer may then correlate the high CPU usage and the security alert as signs of a potential DDoS attack or compromised device, because the high CPU usage and multiple failed login attempts may be linked to an attack scenario. The event analyzer may prioritize the security alert over the high CPU usage event because a potential security breach is more critical. The event analyzer in collaboration with the event reviewer may resolve any ambiguity, for example, whether the high CPU usage event is a result of the DDoS attack or an unrelated issue, and escalate the matter to the action trigger and the action assessor for investigation. The action trigger, in collaboration with the action assessor, may automatically trigger an action such as a security response associated with a network management operation, for example, blocking an IP address associated with the failed login attempts, while also notifying users, for example, network administrators, for further investigation. By filtering out less significant or redundant network events, the collaborative event arbitration cycle may ensure that the network administrators focus on significant issues. Moreover, automated event correlation and prioritization facilitate a quick identification and addressal of critical problems. Further, by correlating security events such as failed logins or abnormal traffic with system behavior such as CPU usage, the collaborative event arbitration cycle can help identify security incidents more effectively. Furthermore, the collaborative event arbitration cycle may help prevent unnecessary interventions by resolving conflicts and minimizing false positives. The collaborative event arbitration cycle may be useful in large-scale networks where the volume of network events can be overwhelming, thereby helping the network administrators focus on critical problems while minimizing noise and reducing the risk of overlooking significant issues.

Although a specific embodiment for a process 800 for collaboratively managing events associated with a network environment suitable for carrying out the various steps, processes, methods, and operations described herein is discussed with respect to FIG. 8, any of a variety of systems and/or processes may be utilized in accordance with embodiments of the disclosure. For example, the process 800 may implement cross-domain network event management with multi-technology integration in the AI-driven CNEM system, where network events from different technological domains such as conventional networking, Software-Defined Networking (SDN), cloud, security systems, applications, or the like, are integrated to provide a comprehensive view and more context for collaborative network event management. The elements depicted in FIG. 8 may also be interchangeable with other elements of FIGS. 1-7 and FIGS. 9-12 as required to realize a particularly desired embodiment.

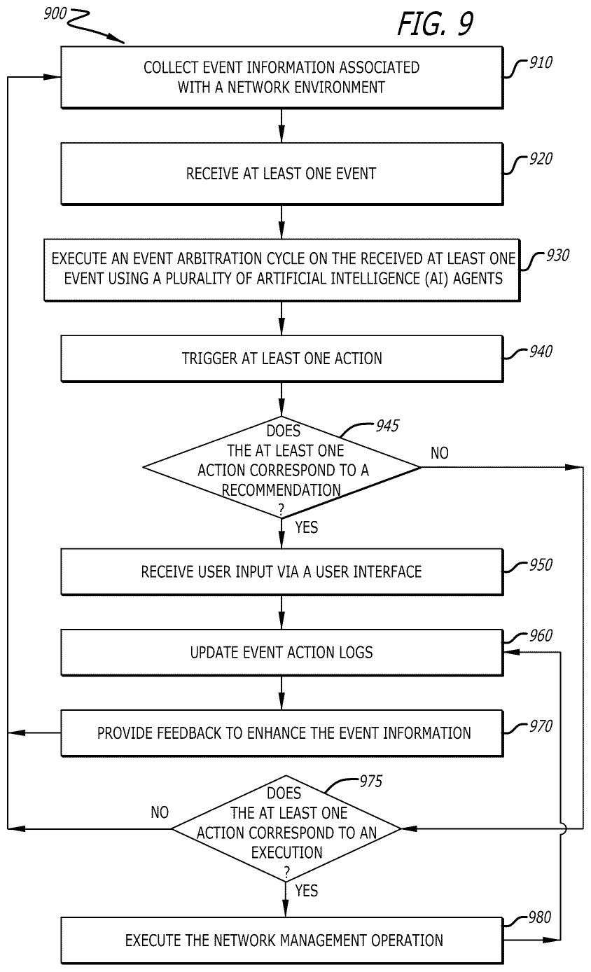

Referring to FIG. 9, a flowchart depicting a process 900 for managing actions based on an event arbitration cycle in accordance with various embodiments of the disclosure is shown. In many embodiments, the process 900 may collect event information associated with a network environment (block 910). The event information may relate to events including, for example, syslog messages, alarms, SNMP traps, incidents, or the like, also referred to as “network events.” In a number of embodiments, the event information may be collected from a local knowledge base configured to provide contextual information associated with the network environment. In a variety of embodiments, the local knowledge base is configured as an embedding vector database. In various embodiments, the process 900 may create and update the local knowledge base by utilizing user data and feedback received from one or more users. In more embodiments, the event information may be collected from a domain knowledge base configured to provide knowledge about a domain associated with the network environment. In additional embodiments, the event information may include one or more requirements associated with at least one policy corresponding to the network environment. The requirement(s) may enumerate specific needs and policies such as identification of critical services, network events, network devices, types of network events that can trigger approved actions, or the like. In further embodiments, the event information may include at least one event category indicating a known event type and a meaning of the known event type. In still more embodiments, the event information may include at least one event action log associated with the network environment. The event action log(s) may track the actions generated by the AI-driven CNEM system discussed herein for executing network management operations.

In still further embodiments, the process 900 may collect the event information from various sources including, for example, network devices such as access points, routers, switches, firewalls, or the like, applications, user actions, feedback, or any combination thereof, in the network environment. In still additional embodiments, the process 900 may collect feedback associated with at least one action via a user interface, for example, a chat interface, rendered by the AI-driven CNEM system, and update the event information based on the collected feedback. In some more embodiments, the process 900 may utilize the event information to implement domain grounding of multiple AI agents that operate collaboratively in the AI-driven CNEM system.

In yet various embodiments, the process 900 may receive at least one event (block 920). The event(s) may relate to a network event including, for example, a syslog message, an alarm, an SNMP trap, an incident, or the like. The process 900 may receive the event(s) from one or more sources including, for example, network devices such as access points, routers, switches, firewalls, or the like, applications, or user actions, in the network environment. In yet more embodiments, the process 900 may receive at least one event at an event arbitration circuit of the AI-driven CNEM system. The event arbitration circuit may operate as the brain of the AI-driven CNEM system and may implement collaborative AI reasoning of the AI agents to autonomously and iteratively make decisions, which drive actions associated with network management operations.

In still yet more embodiments, the process 900 may execute an event arbitration cycle on the received at least one event using a plurality of AI agents (block 930). The process 900 may execute the event arbitration cycle on the received event(s) based on the collected event information. The process 900 may configure the AI agents to operate in the event arbitration cycle. In the event arbitration cycle, the AI agents work together autonomously and collaboratively in an ongoing, self-regulating process to analyze the received event(s), resolve conflicts, make decisions, and trigger actions associated with the network management operations, with minimal or no user intervention. The AI agents may be deployed in the event arbitration circuit of the AI-driven CNEM system. In many further embodiments, the event arbitration cycle may include autonomous arbitration corresponding to the received event(s) and/or the corresponding network management operation(s), by the AI agents.

In many additional embodiments, as part of the event arbitration cycle, the process 900 may evaluate the received event(s). The process 900 may evaluate the received event(s) based on the collected event information. In the event arbitration cycle, each of the AI agents may be configured to execute at least one ML model for the evaluation of the received event(s). The evaluation of the received event(s) may include, for example, performing at least one classification of the received event(s), evaluating the classification(s), generating a relationship graph based on the evaluation, identifying one or more correlations between the received event(s) and another event associated with the network environment based on the generated relationship graph, and assigning a priority to each of the received event(s) and the other event based on the identified correlation(s). The process 900 may continue to run the event arbitration cycle as new events or conflicts arise, enabling the AI-driven CNEM system to dynamically adjust and maintain consistency across all the AI agents. In still yet further embodiments, as part of the event arbitration cycle, the process 900 may determine a network management operation. The process 900 may determine the network management operation based on the evaluation. The network management operation may include, for example, suppressing dependent network events, isolating network devices, shutting down or bringing up an interface, changing configurations, modifying a service construct, or the like.

In still yet additional embodiments, the process 900 may trigger at least one action (block 940). The process 900 may trigger the action(s) based on the event arbitration cycle. Further, the process 900 may trigger the action(s) associated with the determined network management operation. In several embodiments, the process 900 may trigger the action(s) in accordance with a policy configured by a user, for example, a network administrator. The policy may specify whether the action(s) should correspond to a recommendation or an execution.

In several more embodiments, the process 900 may determine whether the action(s) corresponds to a recommendation (block 945). In numerous embodiments, based on the policy configured by the user, initial deployment of the AI-driven CNEM system may allow the AI agents to only make recommendations without executions. In numerous additional embodiments, the process 900 may trigger the action(s) corresponding to the recommendation instead of directly executing the network management operation. In further additional embodiments, the process 900 may transmit the recommendation of the network management operation to the user's device. For example, instead of executing direct changes to network devices based on one or more policies corresponding to the network environment, the process 900 may transmit a recommendation of the changes to the user's device for review by the user.

In many embodiments, in response to determining that the action(s) corresponds to a recommendation, the process 900 may receive user input via a user interface (block 950). The user input may correspond to the network management operation. The user may receive the recommendation of the network management operation on a user interface, for example, a chat interface. The user may review the recommendation and if found appropriate, may initiate one or more network diagnostic tools, configuration tools, or other tools to execute the network management operation. In the above example, if the user finds the recommendation appropriate, the user may initiate one or more configuration tools for executing changes to the network devices based on one or more policies corresponding to the network environment.

In a number of embodiments, the process 900 may update event action logs (block 960). The process 900 may update the event action logs based on the triggered action(s) corresponding to the recommendation. The event action logs may keep track of the action(s) triggered by the AI agents. The event action logs may be stored in an action log database disposed in a domain grounding circuit of the AI-driven CNEM system.

In a variety of embodiments, the process 900 may provide feedback to enhance the event information (block 970). The feedback may provide, for example, an indication on whether the changes to the network devices based on one or more policies were successfully applied or whether there were any failures. The feedback may include, for example, error messages, failed actions, confirmations of successful execution, or the like. The process 900 may receive the feedback associated with the triggered action(s) corresponding to the recommendation via a user interface, for example, a chat interface, rendered by the AI-driven CNEM system. The process 900 may then update the event information based on the received feedback. In various embodiments, the process 900 may then reiterate the process of collecting the event information associated with the network environment (block 910).

However, in more embodiments, in response to determining that the action(s) does not correspond to a recommendation, the process 900 may determine whether the action(s) corresponds to an execution (block 975). In additional embodiments, based on the policy configured by the user, deployment of the AI-driven CNEM system may allow the AI agents to directly proceed with executions of the network management operations, without recommendations. In further embodiments, the process 900 may trigger the action(s) corresponding to the execution of the network management operation instead of making a recommendation of the network management operation. For example, the process 900 may directly trigger the action(s) to a ticket generator operably coupled to a ticketing system for opening a ticket that records the network management operation.

In still more embodiments, in response to determining that the action(s) corresponds to an execution, the process 900 may execute the network management operation (block 980). For example, for isolating network devices, the process 900 may directly proceed to disconnect or segment a network device or a group of network devices from the rest of the network to prevent the network device from impacting other network devices. In a further example, for shutting down or bringing up an interface, the process 900 may directly disable or enable the interface on a network device. The process 900 may then proceed to update the event action logs (block 960), provide feedback to enhance the event information (block 970), and reiterate collecting the event information associated with the network environment (block 910). However, in still further embodiments, in response to determining that the action(s) does not correspond to an execution, the process 900 may reiterate collecting the event information associated with the network environment (block 910).

Although a specific embodiment for a process 900 for managing actions based on an event arbitration cycle suitable for carrying out the various steps, processes, methods, and operations described herein is discussed with respect to FIG. 9, any of a variety of systems and/or processes may be utilized in accordance with embodiments of the disclosure. For example, in still additional embodiments, in addition to actions corresponding to recommendations or executions, one or more of the AI agents may trigger notifications when certain conditions or thresholds are met. If network traffic exceeds predefined threshold limits, or if an interface experiences downtime, the AI agents can transmit notifications to users such as network administrators or trigger alerts in monitoring dashboards. The elements depicted in FIG. 9 may also be interchangeable with other elements of FIGS. 1-8 and FIGS. 10-12 as required to realize a particularly desired embodiment.

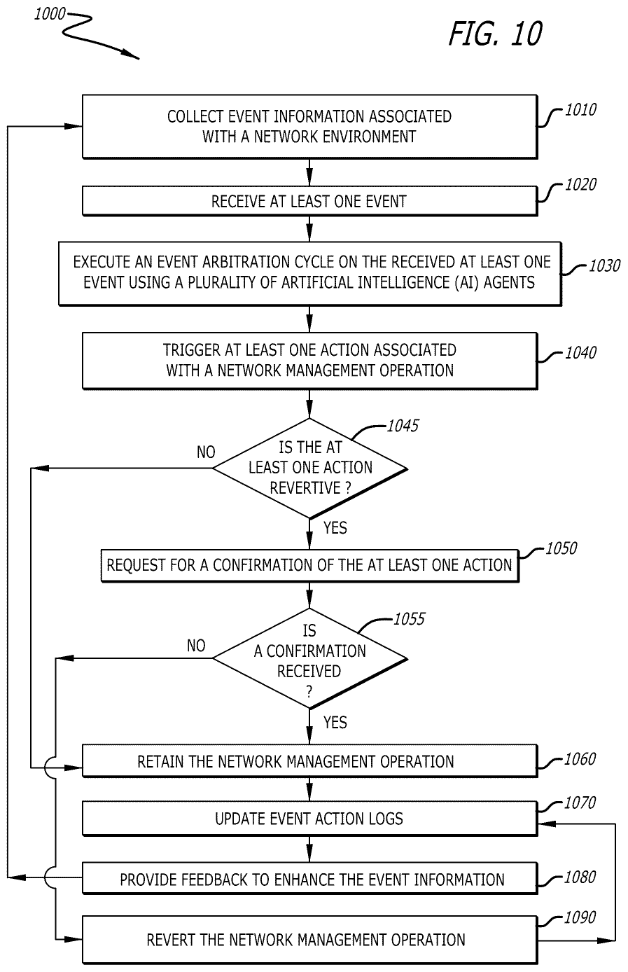

Referring to FIG. 10, a flowchart depicting a process 1000 for managing revertive actions based on an event arbitration cycle in accordance with various embodiments of the disclosure is shown. In many embodiments, the process 1000 may collect event information associated with a network environment (block 1010). The event information may relate to events including, for example, syslog messages, alarms, SNMP traps, incidents, or the like, also referred to as “network events.” In a number of embodiments, the event information may be collected from a local knowledge base configured to provide contextual information associated with the network environment. In a variety of embodiments, the local knowledge base is configured as an embedding vector database. In various embodiments, the process 1000 may create and update the local knowledge base by utilizing user data and feedback received from one or more users. In more embodiments, the event information may be collected from a domain knowledge base configured to provide knowledge about a domain associated with the network environment. In additional embodiments, the event information may include one or more requirements associated with at least one policy corresponding to the network environment. The requirement(s) may enumerate specific needs and policies such as identification of critical services, network events, network devices, types of network events that can trigger approved actions, or the like. In further embodiments, the event information may include at least one event category indicating a known event type and a meaning of the known event type. In still more embodiments, the event information may include at least one event action log associated with the network environment. The event action log(s) may track the actions generated by the AI-driven CNEM system discussed herein for executing network management operations.

In still further embodiments, the process 1000 may collect the event information from various sources including, for example, network devices such as access points, routers, switches, firewalls, or the like, applications, user actions, feedback, or any combination thereof, in the network environment. In still additional embodiments, the process 1000 may collect feedback associated with at least one action via a user interface, for example, a chat interface, rendered by the AI-driven CNEM system, and update the event information based on the collected feedback. In some more embodiments, the process 1000 may utilize the event information to implement domain grounding of multiple AI agents that operate collaboratively in the AI-driven CNEM system.

In yet various embodiments, the process 1000 may receive at least one event (block 1020). The event(s) may relate to a network event including, for example, a syslog message, an alarm, an SNMP trap, an incident, or the like. The process 1000 may receive the event(s) from one or more sources including, for example, network devices such as access points, routers, switches, firewalls, or the like, applications, or user actions, in the network environment. In yet more embodiments, the process 1000 may receive at least one event at an event arbitration circuit of the AI-driven CNEM system. The event arbitration circuit may operate as the brain of the AI-driven CNEM system and may implement collaborative AI reasoning of the AI agents to autonomously and iteratively make decisions, which drive actions associated with network management operations.

In still yet more embodiments, the process 1000 may execute an event arbitration cycle on the received at least one event using a plurality of AI agents (block 1030). The process 1000 may execute the event arbitration cycle on the received event(s) based on the collected event information. In many further embodiments, the event arbitration cycle may include autonomous arbitration corresponding to the received event(s) and/or the corresponding network management operation(s), by the AI agents. The AI agents may be deployed in the event arbitration circuit of the AI-driven CNEM system. The process 1000 may configure the AI agents to operate in the event arbitration cycle. In the event arbitration cycle, the AI agents work together autonomously and collaboratively in an ongoing, self-regulating process to analyze the received event(s), resolve conflicts, make decisions, and trigger actions associated with the network management operations, with minimal or no user intervention.

In many additional embodiments, as part of the event arbitration cycle, the process 1000 may evaluate the received event(s). The process 1000 may evaluate the received event(s) based on the collected event information. In the event arbitration cycle, each of the AI agents may be configured to execute at least one ML model for the evaluation of the received event(s). The evaluation of the received event(s) may include, for example, performing at least one classification of the received event(s), evaluating the classification(s), generating a relationship graph based on the evaluation, identifying one or more correlations between the received event(s) and another event associated with the network environment based on the generated relationship graph, and assigning a priority to each of the received event(s) and the other event based on the identified correlation(s). The process 1000 may continue to run the event arbitration cycle as new events or conflicts arise, enabling the AI-driven CNEM system to dynamically adjust and maintain consistency across all the AI agents. In still yet further embodiments, as part of the event arbitration cycle, the process 1000 may determine a network management operation. The process 1000 may determine the network management operation based on the evaluation. The network management operation may include, for example, suppressing dependent network events, isolating network devices, shutting down or bringing up an interface, changing configurations, modifying a service construct, or the like.

In still yet additional embodiments, the process 1000 may trigger at least one action associated with a network management operation (block 1040). The process 1000 may trigger the action(s) based on the event arbitration cycle. The action(s) may be triggered by at least one of the AI agents, for example, an action trigger. In several embodiments, the process 1000 may trigger the action(s) in accordance with a policy configured by a user, for example, a network administrator. In several more embodiments, the policy may specify whether the action(s) is revertible. In numerous embodiments, the action(s) may be revertible requesting a confirmation of the action(s) from at least one of the AI agents, for example, an action assessor, within a configurable expiration period.

In numerous additional embodiments, the process 1000 may determine whether the at least one action is revertive (block 1045). A revertive action may require at least one of the AI agents, for example, the action assessor, to confirm the action(s) associated with the determined network management operation. A revertive action may need to be confirmed to ensure accuracy, prevent mistakes, and maintain control over critical systems. Reverting to a previous state may sometimes have unintended side effects, especially if the network environment has changed since the original configuration or state was set. For example, a rollback of a network configuration may undo updates that were critical for addressing other issues such as security patches, performance improvements, or the like, potentially reintroducing vulnerabilities or other problems in the network environment.

In further additional embodiments, in response to determining that the at least one action is revertive, the process 1000 may request for a confirmation of the at least one action (block 1050). In many embodiments, the process 1000 may transmit a confirmation request, for example, to the action assessor. In a number of embodiments, the process 1000 may transmit the confirmation request after the network management operation is executed. In an example, the network management operation may include a direct change to a network configuration based on one or more policies corresponding to the network environment. The confirmation request may request for a confirmation of the action(s) associated with the executed network management operation. The action assessor may receive the confirmation request and analyze the executed network management operation.

In a variety of embodiments, the process 1000 may determine whether the confirmation is received (block 1055). During the analysis of the executed network management operation, the process 1000 may determine whether reverting or aborting the executed network management operation may reintroduce vulnerabilities or other problems in the network environment. In the above example, the action assessor may provide a confirmation of the action(s) based on the analysis. In various embodiments, the process 1000 may force a confirmation of the action(s) from the action assessor within the configurable expiration period. The process 1000 may await the reception of the confirmation from the action assessor until the configurable expiration period lapses.

In more embodiments, in response to determining that the confirmation is received, the process 1000 may retain the network management operation (block 1060). During the analysis of the executed network management operation, if the process 1000 determines that reverting or aborting the executed network management operation may reintroduce vulnerabilities or other problems in the network environment, the process 1000 may provide a confirmation of the action(s). The confirmation may include a request to retain the executed network management operation to preclude reintroducing vulnerabilities or other problems in the network environment. The process 1000 may transmit the confirmation within the configurable expiration period for retaining the executed network management operation. If the process 1000 confirms the action(s) within the configurable expiration period, the network management operation that was executed may be retained. In the above example, if the process 1000 confirms the action(s) within the configurable expiration period, the direct change to the network configuration based on one or more policies corresponding to the network environment may be retained.

In additional embodiments, the process 1000 may update event action logs (block 1070). The process 1000 may update the event action logs based on the triggered action(s). The event action logs may keep track of the action(s) triggered by the AI agents. The event action logs may be stored in an action log database disposed in a domain grounding circuit of the AI-driven CNEM system.

In further embodiments, the process 1000 may provide feedback to enhance the event information (block 1080). The feedback may provide, for example, an indication on whether the change to the network configuration based on one or more policies was successfully applied or whether there were any failures. The feedback may include, for example, error messages, failed actions, confirmations of successful execution, or the like. The process 1000 may receive the feedback associated with the triggered action(s) corresponding to the recommendation via a user interface, for example, a chat interface, rendered by the AI-driven CNEM system. The process 1000 may then update the event information based on the received feedback. In still more embodiments, the process 1000 may then reiterate the process of collecting the event information associated with the network environment (block 1010).

However, in still further embodiments, in response to determining that the confirmation is not received, the process 1000 may revert the network management operation (block 1090). If the process 1000 does not provide a confirmation of the action(s) within the configurable expiration period, the process 1000 may revert the network management operation. Failure to provide the confirmation of the action(s) may indicate that the action(s) is not confirmed. The unconfirmed action(s) may indicate that the executed network management operation must be reverted or aborted. In the above example, if the process 1000 does not confirm the action(s) within the configurable expiration period, the process 1000 may execute a rollback of the network configuration. In still additional embodiments, the process 1000 may then proceed to update the event action logs (block 1070), provide feedback to enhance the event information (block 1080), and reiterate collecting the event information associated with the network environment (block 1010).

Although a specific embodiment for a process 1000 for managing revertive actions based on an event arbitration cycle suitable for carrying out the various steps, processes, methods, and operations described herein is discussed with respect to FIG. 10 any of a variety of systems and/or processes may be utilized in accordance with embodiments of the disclosure. For example, in some more embodiments, the process 1000 may analyze the actions and perform action dry runs prior to execution of the actions, thereby precluding the need for reverting the actions. The elements depicted in FIG. 10 may also be interchangeable with other elements of FIGS. 1-9 and FIGS. 11-12 as required to realize a particularly desired embodiment.

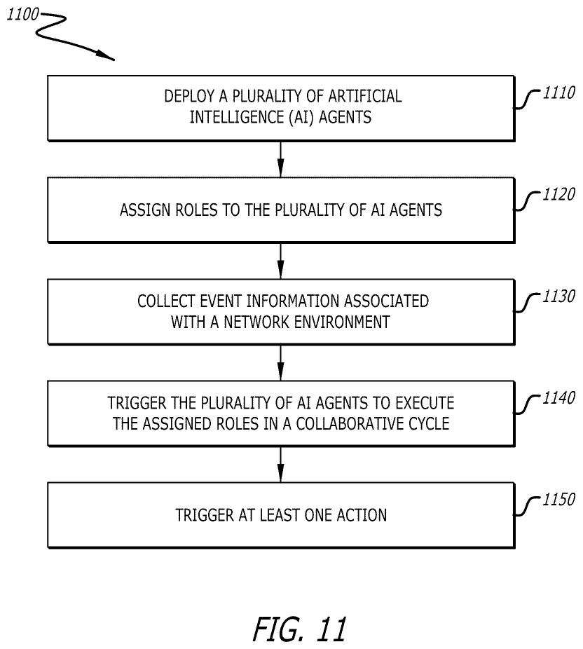

Referring to FIG. 11, a flowchart depicting a process 1100 for collaborative role-based management of events associated with a network environment in accordance with various embodiments of the disclosure is shown. In many embodiments, the process 1100 may deploy a plurality of AI agents (block 1110). In a number of embodiments, the AI agents may correspond to generative AI agents. The AI agents may be configured to operate in a collaborative cycle for performing the collaborative role-based management of events associated with a network environment. The collaborative role-based management of events may include, for example, event planning, event analysis, event review, graph generation, action trigger, action assessment, ticket generation, event reporting, or the like. The AI agents may work autonomously and collaboratively in an ongoing, self-regulating process to resolve conflicts, make decisions, and ensure consistency across the AI-driven CNEM system without requiring constant user intervention.

In a variety of embodiments, the process 1100 may assign roles to the plurality of AI agents (block 1120). By way of a non-limiting example, the process 1100 may assign the roles, namely, an event planner, an event ingester, an event analyzer, an event reviewer, a graph generator, an action assessor, an action trigger, a ticket generator, and an event reporter, to nine (9) AI agents. The process 1100 may configure the AI agents to execute their assigned roles in the collaborative cycle. The process 1100 may configure the AI agents to execute at least one ML model, for example, an LLM, an LAM, or the like to perform the collaborative role-based management of events based on their assigned roles.

In various embodiments, the process 1100 may collect event information associated with a network environment (block 1130). The process 1100 may configure the event planner to collect the event information. The event information may relate to events including, for example, syslog messages, alarms, SNMP traps, incidents, or the like, also referred to as “network events.” In more embodiments, the event information may be collected from a local knowledge base configured to provide contextual information associated with the network environment. In additional embodiments, the local knowledge base is configured as an embedding vector database. In further embodiments, the process 1100 may create and update the local knowledge base by utilizing user data and feedback received from one or more users. In still more embodiments, the event information may be collected from a domain knowledge base configured to provide knowledge about a domain associated with the network environment. In still further embodiments, the event information may include one or more requirements associated with at least one policy corresponding to the network environment. The requirement(s) may enumerate specific needs and policies such as identification of critical services, network events, network devices, types of network events that can trigger approved actions, or the like. In still additional embodiments, the event information may include at least one event category indicating a known event type and a meaning of the known event type. In some more embodiments, the event information may include at least one event action log associated with the network environment. The event action log(s) may track the actions generated by the AI-driven CNEM system discussed herein for executing network management operations.

In yet various embodiments, the process 1100 may collect the event information from various sources including, for example, network devices such as access points, routers, switches, firewalls, or the like, applications, user actions, feedback, or any combination thereof, in the network environment. In yet more embodiments, the process 1100 may collect feedback associated with at least one action via a user interface, for example, a chat interface, rendered by the AI-driven CNEM system, and update the event information based on the collected feedback. In still yet more embodiments, the process 1100 may utilize the event information to implement domain grounding of multiple AI agents that operate collaboratively in the AI-driven CNEM system.

In many further embodiments, the process 1100 may trigger the plurality of AI agents to execute the assigned roles in a collaborative cycle (block 1140). These AI agents may execute ML models, for example, LLMs and Large Action Models (LAMs), which may be general foundational models based on their large model weights for better reasoning or smaller specially tuned models for networking use cases for better expertise. The event ingester may receive the network events from the network environment. The process 1100 may receive the network events from one or more sources including, for example, network devices such as access points, routers, switches, firewalls, or the like, applications, or user actions, in the network environment. The event ingester may execute at least one ML model, for example, an LLM, for processing the network events through operations such as cleaning, deduplication, enrichment, event classification, and relationship identification.

In addition to receiving the event information, the event planner may receive and synthesize user input, and execute at least one ML model, for example, an LLM, for planning operations to be performed by the other AI agents, prioritizing the processed network events, and generating decision paths for the network events. In many additional embodiments, the event analyzer may perform event correlation, root cause analysis, anomaly analysis, local knowledge retrieval for human knowledge including, for example, local Retrieval-Augmented Generation (RAG), or the like. The event analyzer may utilize the event information to enhance the knowledge of the ML model(s). In still yet further embodiments, the event reviewer may execute at least one ML model, for example, an LLM, for reviewing the analytical results received from the event analyzer and generating feedback corresponding to the network events. In still yet additional embodiments, the graph generator may execute at least one ML model, for example, an LLM, for mapping out relationships between various components in the network environment, the network events, and anomalies, and generating a dependency graph. The graph generator may utilize the event information to perform correlations of different types and generate the dependency graph. In several embodiments, the event reviewer may perform a graph walk, that is, a process of traversing or exploring the nodes and edges within the dependency graph to gain insights, analyze the network events, or track how issues propagate across the network. In several more embodiments, the action trigger may execute at least one ML model, for example, an LAM, for determining network management operations configured to address critical network events based on the collaborative evaluation performed by the event analyzer, the event reviewer, and the graph generator. The network management operations may include, for example, suppressing dependent network events, isolating a network device, directly changing the network device based on a policy, shutting down or bringing up an interface, changing configurations, modifying a service construct, or the like.

In numerous embodiments, the process 1100 may trigger at least one action (block 1150). The process 1100 may trigger the action(s) through the action trigger. The action assessor may review the action(s), perform a resource assessment, and conduct action dry runs to ensure the action(s) proposed by the action trigger is reasonable and can be executed with appropriate network resources. In numerous additional embodiments, the action assessor may execute at least one ML model, for example, an LAM, for evaluating, prioritizing, and assessing the impact of the action(s) associated with the network management operations. In further additional embodiments, the action trigger may trigger an action to the ticket generator that also operates as an AI agent. The ticket generator may perform tool calls to a ticketing system to open a context-filled ticket for executing a network management operation. In many embodiments, the action trigger may trigger an action to the event reporter that also operates as an AI agent. The event reporter may generate event reports to allow customization and interactions with the AI-driven CNEM system. In a number of embodiments, the event reporter may execute at least one ML model, for example, an LLM, for generating the event reports.

Although a specific embodiment for a process 1100 for collaborative role-based management of events associated with a network environment suitable for carrying out the various steps, processes, methods, and operations described herein is discussed with respect to FIG. 11, any of a variety of systems and/or processes may be utilized in accordance with embodiments of the disclosure. For example, in a variety of embodiments, the process 1100 may dynamically assign roles to the AI agents depending on the network environment and tasks needed in the collaborative cycle. The elements depicted in FIG. 11 may also be interchangeable with other elements of FIGS. 1-10 and FIG. 12 as required to realize a particularly desired embodiment.

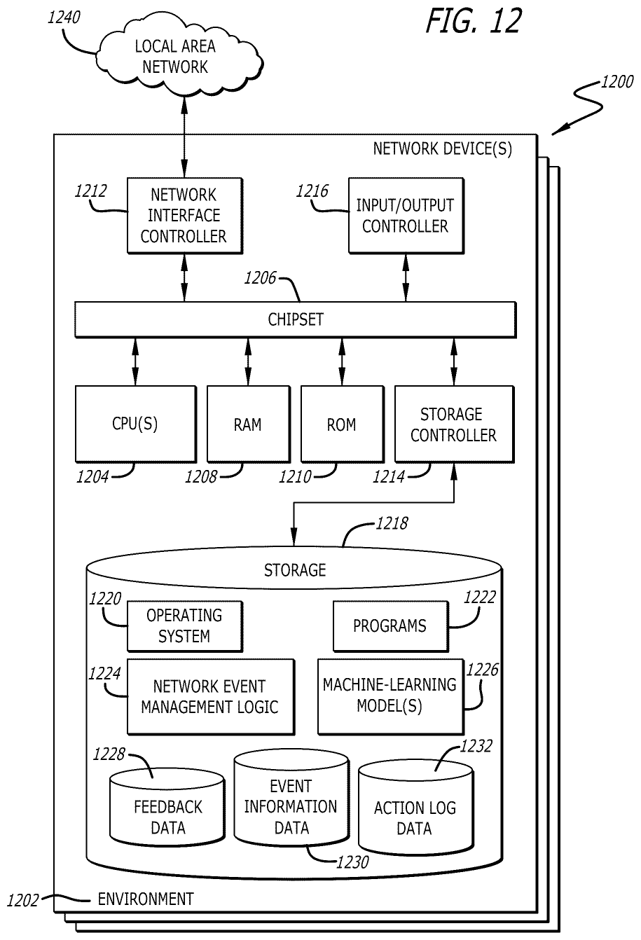

Referring to FIG. 12, a conceptual block diagram of a device 1200 suitable for configuration with the network event management logic 1224 for implementing the functionality and various embodiments of the disclosure is shown. The embodiment of the device 1200 in the conceptual block diagram depicted in FIG. 12 may relate to a conventional server computer, a workstation, a desktop computer, a laptop, a tablet, a network appliance, an electronic reader (e-reader), a smartphone, or other computing device, and can be utilized to execute any of the application and/or logic components presented herein. The device 1200 may, in some examples, correspond to a physical device or to a virtual resource described herein. The device 1200 can be a network device, for example, an access point, a router, a switch, any type of edge-based network device, or the like in accordance with various embodiments of the disclosure.

In many embodiments, the device 1200 may include an environment 1202 such as a baseboard or a “motherboard,” in physical embodiments that can be configured as a printed circuit board with a multitude of components or devices connected by way of a system bus or other electrical communication paths. Conceptually, in virtualized embodiments, the environment 1202 may be a virtual environment that encompasses and executes the remaining components and resources of the device 1200. In a number of embodiments, one or more processors 1204, such as, but not limited to, CPUs can be configured to operate in conjunction with a chipset 1206. The processor(s) 1204 can be standard programmable CPUs that perform arithmetic and logical operations necessary for the operation of the device 1200.

In a variety of embodiments, the processor(s) 1204 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1206 may provide an interface between the processor(s) 1204 and the remainder of the components and devices within the environment 1202. The chipset 1206 can provide an interface to a Random-Access Memory (RAM) 1208, which can be utilized as the main memory in the device 1200 in some embodiments. The chipset 1206 can further be configured to provide an interface to a computer-readable storage medium such as a Read-Only Memory (ROM) 1210 or a Non-Volatile RAM (NVRAM) for storing basic routines that can help with various tasks such as, but not limited to, starting up the device 1200 and/or transferring information between the various components and devices. The ROM 1210 or NVRAM can also store other application components necessary for the operation of the device 1200 in accordance with various embodiments described herein.

Different embodiments of the device 1200 can be configured to operate in a networked environment using logical connections to remote computing devices and computer systems through a network, such as the LAN 1240. The chipset 1206 can include functionality for providing network connectivity through a Network Interface Controller (NIC) 1212, which may include a gigabit Ethernet adapter or similar component. The NIC 1212 can be capable of connecting the device 1200 to other devices over the LAN 1240. It is contemplated that multiple NICs 1212 may be present in the device 1200, connecting the device 1200 to other types of networks and remote systems.

In more embodiments, the device 1200 can be connected to a storage 1218 that provides non-volatile storage for data accessible by the device 1200. The storage 1218 can, for example, store an operating system 1220, applications or programs 1222, feedback data 1228, event information data 1230, and action log data 1232, which are described in greater detail below. The storage 1218 can be connected to the environment 1202 through a storage controller 1214 connected to the chipset 1206. In additional embodiments, the storage 1218 can include one or more physical storage units. The storage controller 1214 can interface with the physical storage units through a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units.

The device 1200 can store data within the storage 1218 by transforming the physical state of the physical storage units to reflect the information being stored. The specific transformation of the physical state can depend on various factors. Examples of such factors can include, but are not limited to, the technology utilized to implement the physical storage units, whether the storage 1218 is characterized as primary or secondary storage, and the like. For example, the device 1200 can store information within the storage 1218 by issuing instructions through the storage controller 1214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1200 can further read or access information from the storage 1218 by detecting the physical states or characteristics of one or more particular locations within the physical storage units.

In addition to the storage 1218 described above, the device 1200 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1200. In some examples, the operations performed by a cloud computing network, and or any components included therein, may be supported by one or more devices similar to the device 1200. Stated otherwise, some or all of the operations performed by the cloud computing network, and or any components included therein, may be performed by the device 1200 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, Erasable Programmable ROM (EPROM), Electrically-Erasable Programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1218 can store an operating system 1220 utilized to control the operation of the device 1200. According to one embodiment, the operating system 1220 includes the LINUX operating system. According to another embodiment, the operating system 1220 includes the Windows® server operating system from Microsoft Corporation of Redmond, Washington. According to further embodiments, the operating system 1220 can include the UNIX operating system or one of its variants. It should be appreciated that other operating systems can also be utilized. The storage 1218 can store other system or application programs and data utilized by the device 1200.

In still more embodiments, the storage 1218 or other computer-readable storage media is encoded with computer-executable instructions which, when loaded into the device 1200, may transform the device 1200 from a general-purpose computing system into a special-purpose computer capable of implementing the embodiments described herein. These computer-executable instructions may be stored as applications or programs 1222 and transform the device 1200 by specifying how the processor(s) 1204 can transition between states, as described above. In still further embodiments, the device 1200 has access to computer-readable storage media storing computer-executable instructions which, when executed by the device 1200, perform the various processes described above with regard to FIGS. 1-11. In still additional embodiments, the device 1200 can also include computer-readable storage media having instructions stored thereupon for performing any of the other computer-implemented operations described herein.

In some more embodiments, the device 1200 can also include one or more input/output controllers 1216 for receiving and processing input from a number of input devices, such as a keyboard, a mouse, a touchpad, a touch screen, an electronic stylus, or other type of input device. Similarly, an input/output controller 1216 can be configured to provide output to a display, such as a computer monitor, a flat panel display, a digital projector, a printer, or other type of output device. Those skilled in the art will recognize that the device 1200 may not include all of the components shown in FIG. 12, and can include other components that are not explicitly shown in FIG. 12, or may utilize an architecture completely different than that shown in FIG. 12.

As described above, the device 1200 may support a virtualization layer, such as one or more virtual resources executing on the device 1200. In some examples, the virtualization layer may be supported by a hypervisor that provides one or more virtual machines running on the device 1200 to perform functions described herein. The virtualization layer may generally support a virtual resource that performs at least a portion of the techniques described herein.

In yet various embodiments, the device 1200 can include a network event management logic 1224 that may be responsible for evaluating events associated with a network environment, determining network management operations, and triggering associated actions, based on an autonomous and collaborative cycle that is grounded by local context and knowledge. In yet more embodiments, the network event management logic 1224 may operate in an automation system. In embodiments where the device 1200 corresponds to the automation system, the network event management logic 1224 can be configured to perform various operations such as, but not limited to, receiving event information associated with the network environment; and using the plurality of AI agents to: receive at least one event; evaluate the received event(s) based on the received event information; determine a network management operation based on the evaluation; and trigger at least one action associated with the determined network management operation. In still yet more embodiments where the device 1200 corresponds to the automation system, the network event management logic 1224 can be configured to perform various operations such as, but not limited to, collecting event information associated with a network environment; receiving at least one event; executing an event arbitration cycle on the received event(s) using the plurality of AI agents based on the collected event information; and triggering at least one action based on the event arbitration cycle. Further, in many further embodiments where the device 1200 corresponds to the automation system, the network event management logic 1224 can be configured to perform various operations such as, but not limited to, receiving event information associated with a network environment; deploying a plurality of AI agents; and executing, using the plurality of AI agents, a collaborative event arbitration cycle comprising: receiving at least one event; evaluating the received event(s) based on the received event information; determining a network management operation based on the evaluation; and triggering at least one action associated with the determined network management operation.

Those skilled in the art will recognize that the network event management logic 1224 can include various hardware and/or software deployments and can be configured in a variety of ways. In many additional embodiments, the network event management logic 1224 can be configured as a standalone device, exist as a logic in another network device, be distributed among various network devices operating in tandem, or remotely operated as part of a cloud-based network management tool. In still yet further embodiments, one or more servers can be configured with the network event management logic 1224 or can otherwise operate as the network event management logic 1224. In still yet additional embodiments, the network event management logic 1224 may operate on one or more servers connected to a communication network, for example, the Internet. The communication network can include wired networks or wireless networks. The network event management logic 1224 can be provided as a cloud-based service that can service remote networks, such as, but not limited to, a deployed network. Further, in several embodiments, the network event management logic 1224 may be operated as a distributed logic across multiple network devices. In an embodiment, the controller can operate as the network event management logic 1224 or may have multiple devices operate as the network event management logic 1224 in a distributed manner.

In further additional embodiments, the storage 1218 can include feedback data 1228. The feedback data 1228 may relate to data representative of feedback provided by users in the network environment. The feedback may allow continuous self-learning by the AI agents. The feedback may also further enhance the domain grounding implemented by the AI-driven CNEM system.

In several more embodiments, the storage 1218 can include event information data 1230. The event information data 1230 may relate to data representative of events including, for example, syslog messages, alarms, SNMP traps, incidents, or the like, also referred to as “network events.”. The event information data 1230 may include, for example, contextual information associated with the network environment, knowledge about a domain associated with the network environment, one or more requirements associated with at least one policy corresponding to the network environment, at least one event category indicating a known event type and a meaning of the known event type, feedback received from one or more users, or the like. The event information may be utilized for domain grounding the AI agents with local context and knowledge.

In many embodiments, the storage 1218 can include action log data 1232. The action log data 1232 may relate to data representative of the actions triggered by the AI agents. For example, the action log data 1232 may include information of the actions associated with the network management operations determined and tracked by the AI agents. In a number of embodiments, the action log data 1232 may also further enhance the domain grounding implemented by the AI-driven CNEM system.

In a variety of embodiments, data may be processed into a format usable by an ML model(s) 1226 (e.g., feature vectors), and/or other pre-processing techniques. The ML model(s) 1226 may be any type of ML model(s), such as supervised models, reinforcement models, and/or unsupervised models. The ML model(s) 1226 may include one or more of linear regression models, logistic regression models, decision trees, Naïve Bayes models, neural networks, k-means cluster models, random forest models, and/or other types of ML models. The ML model(s) may include an LLM, an LAM, or the like. In various embodiments, the ML model(s) 1226 may be configured to analyze the event information data 1230 for learning a first set of features that represents network events. In more embodiments, the ML model(s) 1226 may be configured to analyze the feedback data 1228 and the action log data 1232 and enhance the domain grounding of the AI agents. In further embodiments, the ML model(s) 1226 may be utilized to identify various parameters to include in the event information data 1230. For example, the ML model(s) 1226 may analyze the event information data 1230 and identify parameters that are required to augment the event information data 1230. Once the parameters are identified, the network event management logic 1224 may utilize the parameters to evaluate events associated with a network environment, determine network management operations, and trigger associated actions, based on an autonomous and collaborative cycle that is grounded by local context and knowledge.

Although a specific embodiment for a device 1200 suitable for configuration with the network event management logic 1224 for carrying out the various steps, processes, methods, and operations described herein is discussed with respect to FIG. 12, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the network event management logic 1224 acts in tandem between the devices. The elements depicted in FIG. 12 may also be interchangeable with other elements of FIGS. 1-11 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous,” “exemplary,” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A system, comprising:
a processor;
a memory communicatively coupled to the processor, wherein the memory comprises a plurality of Artificial Intelligence (AI) agents configured to operate in a collaborative cycle; and
a network event management logic configured to:
receive event information associated with a network environment; and
using the plurality of AI agents:
receive at least one event;
evaluate the received at least one event based on the received event information;
determine a network management operation based on the evaluation; and
trigger at least one action associated with the determined network management operation.

2. The system of claim 1, wherein the event information is received from a local knowledge base configured to provide contextual information associated with the network environment.

3. The system of claim 2, wherein the local knowledge base is configured as an embedding vector database.

4. The system of claim 2, wherein the network event management logic is further configured to:
receive feedback associated with the at least one action via a user interface; and
update the local knowledge base based on the received feedback.

5. The system of claim 1, wherein the event information is received from a domain knowledge base configured to provide knowledge about a domain associated with the network environment.

6. The system of claim 1, wherein the event information comprises one or more requirements associated with at least one policy corresponding to the network environment.

7. The system of claim 1, wherein the event information comprises at least one event category indicating a known event type and a meaning of the known event type.

8. The system of claim 1, wherein the event information comprises at least one event action log associated with the network environment.

9. The system of claim 8, wherein the network event management logic is further configured to update the at least one event action log based on the triggered at least one action.

10. The system of claim 1, wherein an AI agent of the plurality of AI agents is configured to execute at least one machine learning model for the evaluation of the received at least one event.

11. The system of claim 1, wherein the evaluation of the received at least one event comprises:
performing at least one classification of the received at least one event;
evaluating the at least one classification;
generating a relationship graph based on the evaluation;
identifying one or more correlations between the received at least one event and another event associated with the network environment based on the generated relationship graph; and
assigning a priority to each of the received at least one event and the another event based on the identified one or more correlations.

12. The system of claim 1, wherein the at least one action corresponds to one of a recommendation or an execution.

13. The system of claim 1, wherein an AI agent of the plurality of AI agents has a designated role in the collaborative cycle.

14. The system of claim 1, wherein the network event management logic is further configured to render a user interface that facilitates one or more interactions between a user and the plurality of AI agents, wherein the triggering of the at least one action is based on the one or more interactions.

15. The system of claim 1, wherein the plurality of AI agents corresponds to generative AI agents.

16. The system of claim 1, wherein the at least one action is revertible requesting a confirmation of the at least one action from at least one AI agent of the plurality of AI agents within a configurable expiration period.

17. The system of claim 1, wherein the collaborative cycle comprises autonomous arbitration corresponding to at least one of the received at least one event or the determined network management operation, by the plurality of AI agents.

18. A system, comprising:
a processor; and
a memory communicatively coupled to the processor, wherein the memory comprises a network event management logic configured to:
collect event information associated with a network environment;
receive at least one event;
execute an event arbitration cycle on the received at least one event using a plurality of Artificial Intelligence (AI) agents based on the collected event information; and
trigger at least one action based on the event arbitration cycle.

19. The system of claim 18, wherein the event information is collected from at least one of:
a local knowledge base configured to provide contextual information associated with the network environment; or
a domain knowledge base configured to provide knowledge about a domain associated with the network environment.

20. A method, comprising:
receiving event information associated with a network environment;
deploying a plurality of Artificial Intelligence (AI) agents; and
executing, using the plurality of AI agents, a collaborative event arbitration cycle comprising:
receiving at least one event;
evaluating the received at least one event based on the received event information;
determining a network management operation based on the evaluation; and
triggering at least one action associated with the determined network management operation.
